(19) United States
(12) Patent Application Publication
(10) Pub. No.: US 2026/0156379 A1
(43) Pub. Date: Jun. 4, 2026

(54) IMAGE SENSOR SUPPORTING AUTOFOCUSING AND HIGH DYNAMIC RANGE AND METHOD OF OPERATING THE SAME

(71) Applicant: SAMSUNG ELECTRONICS CO., LTD., Suwon-si (KR)

(72) Inventors: SE-HWAN YUN, Suwon-si (KR); JAESEONG YU, Suwon-si (KR)

(73) Assignee: SAMSUNG ELECTRONICS CO., LTD., Suwon-si (KR)

(21) Appl. No.: 19/379,253

(22) Filed: Nov. 4, 2025

(30) Foreign Application Priority Data
Dec. 3, 2024 (KR) 10-2024-0177682

(51) Int. Cl. H04N 25/57; H04N 23/667; H04N 23/67; H04N 25/13; H04N 25/46; H04N 25/78

(52) U.S. Cl. CPC H04N 25/57; H04N 23/667; H04N 23/672; H04N 25/134; H04N 25/46; H04N 25/78

(57) ABSTRACT

An image sensor includes a pixel array including a plurality of pixel groups and configured to output a pixel signal, and a readout circuit configured to output a first image signal during a first readout period and a second image signal during a second readout period based on the pixel signal. The plurality of pixel groups may each include a plurality of pixels sharing a microlens. During the first readout period, a first pixel group may output a (1-1)-th pixel signal obtained by summing pixel signals of some pixels disposed at positions with opposite phase information in a predetermined direction with respect to the microlens, and a second pixel group and a third pixel group may output a (1-2)-th pixel signal obtained by summing pixel signals of some pixels disposed at positions with the same phase information in the predetermined direction with respect to the microlens.

### CROSS-REFERENCE TO RELATED APPLICATION(S)

This U.S. non-provisional application claims priority under 35 USC § 119 to Korean Patent Application No. 10-2024-0177682, filed on Dec. 3, 2024, in the Korean Intellectual Property Office, the disclosure of which is herein incorporated by reference in its entirety.

### BACKGROUND

Example embodiments relate to a complementary metal oxide semiconductor (CMOS) image sensor and, more particularly, to an image sensor supporting autofocusing (AF) and a high dynamic range (HDR).

An image sensor is configured to convert optical signals into electrical signals.

Image sensors have been developed to enhance a dynamic range of images for improved quality in diverse environments, while reducing a pixel size to increase resolution. In addition, an autofocusing function is used in image sensors to automatically detect focus. Phase difference autofocusing (PDAF) adjusts a focal length based on a phase difference of optical signals sensed by different photoelectric conversion elements such as photodiodes.

### SUMMARY

Example embodiments provide an image sensor that may generate image data having a high dynamic range (HDR) and phase information for autofocusing, even in environments in which some pixel signals are saturated.

According to an aspect of an example embodiment, there is provided an image sensor including: a pixel array including a plurality of pixel groups and configured to output a pixel signal; and a readout circuit configured to output a first image signal based on the pixel signal output during a first readout period, and output a second image signal based on the pixel signal output during a second readout period, wherein each pixel group of the plurality of pixel groups includes a plurality of pixels sharing a microlens, and wherein, during the first readout period, a first pixel group among the plurality of pixel groups is configured to output a (1-1)-th pixel signal obtained by summing pixel signals of some pixels disposed at positions with opposite phase information in a predetermined direction with respect to the microlens, and a second pixel group and a third pixel group among the plurality of pixel groups are configured to output a (1-2)-th pixel signal obtained by summing pixel signals of some pixels disposed at positions with the same phase information in the predetermined direction with respect to the microlens.

According to an aspect of an example embodiment, there is provided an image sensor including: a pixel array including a plurality of pixel groups and configured to output a first pixel signal during a first readout period and output a second pixel signal during a second readout period, for each pixel group of the plurality of pixel groups; at least one microlens disposed above each pixel group of the plurality of pixel groups to overlap each pixel group of the plurality of pixel groups in a direction perpendicular to a substrate of the image sensor, and shared by a plurality of pixels; and a readout circuit configured to output image signals based on the first pixel signal and the second pixel signal, wherein during the first readout period, a first pixel group among the plurality of pixel groups is configured to output, as the first pixel signal, a (1-1)-th pixel signal obtained by summing pixel signals of first pixels, and a second pixel group and a third pixel group among the plurality of pixel groups is configured to output, as the first pixel signal, a (1-2)-th pixel signal obtained by summing pixel signals of second pixels, and wherein the first pixels in the first pixel group are disposed symmetrically in a horizontal direction with respect to a vertical central axis of the at least one microlens, and the second pixels in the second and third pixel groups are disposed at positions along the horizontal direction.

According to an aspect of an example embodiment, there is provided a method of operating an image sensor including: outputting, by a plurality of pixel groups, a first pixel signal and a second pixel signal, outputting, by a readout circuit, a first image signal and a second image signal based on the first pixel signal and the second pixel signal, respectively, and outputting, by an image signal processing circuit, phase data based on the first image signal and the second image signal. The first pixel signal may include a (1-1)-th pixel signal and a (1-2)-th pixel signal. At least one pixel group among the plurality of pixel groups is configured to output the (1-1)-th pixel signal obtained by summing pixel signals of some pixels disposed at positions with opposite phase information and corresponding to a microlens, and other pixel groups among the plurality of pixel groups are configured to output the (1-2)-th pixel signal obtained by summing pixel signals of some pixels disposed at positions with the same phase information and corresponding to the microlens.

### BRIEF DESCRIPTION OF DRAWINGS

The above and/or other aspects will be more apparent by describing certain embodiments with reference to the accompanying drawings, in which:

FIG. 1 is a block diagram illustrating a configuration of an image sensor according to an example embodiment;

FIGS. 2A to 2C are diagrams illustrating pixels according to example embodiments;

FIG. 3 is a plan view of a pixel group according to an example embodiment;

FIG. 4 is a circuit diagram of a pixel group according to an example embodiment;

FIG. 5 is a diagram illustrating a change in an image signal according to a comparative example;

FIG. 6 is a diagram illustrating image signals according to an example embodiment;

FIGS. 7A and 7B are diagrams illustrating pixel signals according to an example embodiment;

FIG. 8 is a timing diagram of control signals provided to pixel groups according to the example embodiment of FIGS. 7A and 7B;

FIG. 9 is a diagram illustrating a pixel signal according to an example embodiment;

FIGS. 10A to 10D are diagrams illustrating pixel signals according to example embodiments;

FIG. 11 is a block diagram illustrating a configuration of a high dynamic range (HDR) processing circuit in an image signal processing circuit according to an example embodiment;

FIG. 12 is a diagram illustrating a color transfer operation of an HDR processing circuit according to an example embodiment;

FIG. 13 is a block diagram illustrating a configuration of an autofocusing (AF) processing circuit in an image signal processing circuit according to an example embodiment;

FIG. 14 is a block diagram illustrating a configuration of an AF processing circuit in an image signal processing circuit according to an example embodiment;

FIGS. 15 and 16 are block diagrams of image sensors according to example embodiments;

FIG. 17 is a block diagram of an imaging device according to an example embodiment; and

FIGS. 18 and 19 are flowcharts illustrating methods of operating an image sensor according to example embodiments.

### DETAILED DESCRIPTION

Hereinafter, example embodiments will be described with reference to the accompanying drawings.

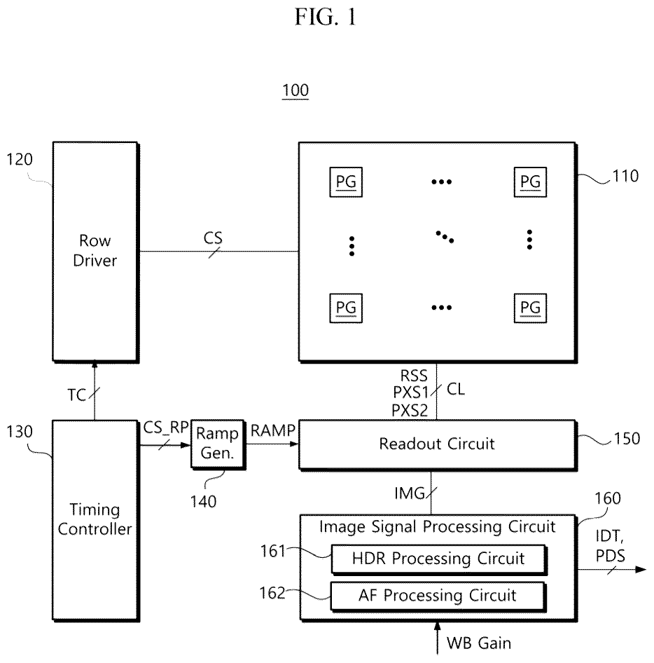

FIG. 1 is a block diagram of an image sensor 100 according to an example embodiment.

In an autofocusing mode, a pixel array 110 may output a first pixel signal PXS1 during a first readout period and a second pixel signal PXS2 during a second readout period. Some pixel groups PG of the pixel array 110 may output a first pixel signal PXS1 with removed or reduced phase information during the first readout period. Other pixel groups of the pixel array 110 may output a first pixel signal PXS1 including phase information during the first readout period. Each pixel group PG of the pixel array 110 may output a second pixel signal PXS2, which is a combination of pixel signals from all pixels within the pixel group PG, during the second readout period.

The image sensor 100 according to an example embodiment will be described in detail with reference to FIG. 1.

The image sensor 100 may output image data based on visual information of an object captured through a lens.

The image sensor 100 may include the pixel array 110, a row driver 120, a timing controller 130, a ramp signal generator 140, a readout circuit 150, and an image signal processing circuit 160.

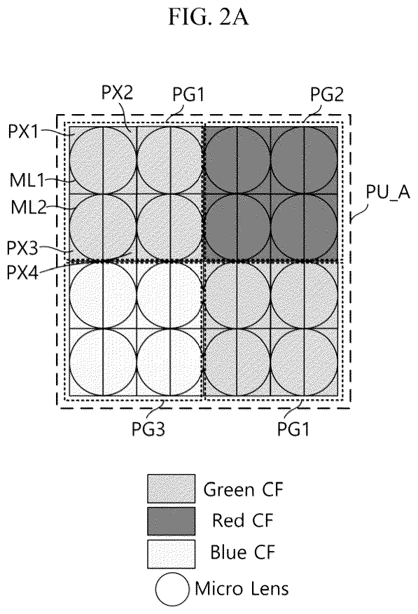

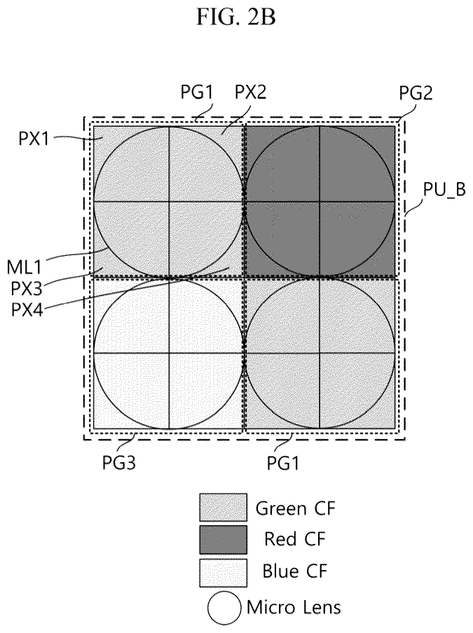

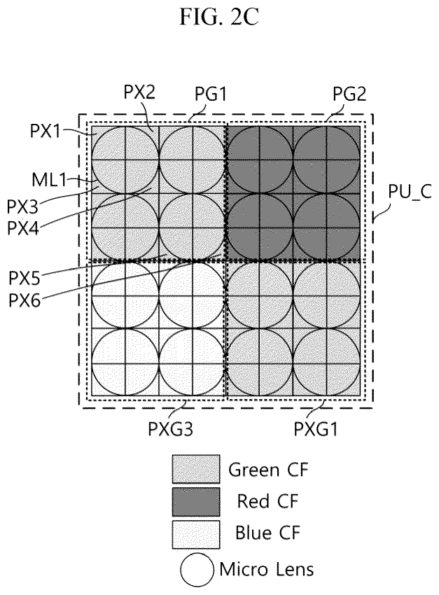

The pixel array 110 may include a plurality of pixel groups PGs. A pixel group PG may include a plurality of pixels. This will be described later in more detail with reference to FIG. 2.

The pixel array 110 may receive, from the row driver 120, a plurality of pixel driving signals CS, such as a select signal for controlling a selection transistor, a reset signal for controlling a reset transistor, and a transfer transistor control signal for controlling a transfer transistor. Each of a plurality of pixel units PXUs in the pixel array 110 may operate under control of the pixel driving signals CS received from the row driver 120. The plurality of pixels included in each pixel group PG may operate under the control of the pixel driving signals CS received from the row driver 120.

The plurality of pixel groups PGs may, for example, be arranged in a matrix. In an example embodiment, each of the plurality of pixel groups PGs and/or each pixel within a pixel group PG may be electrically connected to a row line and a column line.

Each pixel group PG may include a plurality of pixels. Each of the plurality of pixels may include a photoelectric conversion element.

The plurality of pixels may generate photocharges based on an optical signal received through a lens and a color filter.

In an example embodiment, the image sensor 100 may include a Bayer pattern color filter. Example embodiments are described with reference to an example in which the image sensor 100 includes a Bayer pattern color filter. However, example embodiments are not limited to a Bayer pattern color filter and may include various color filter arrays such as RGBW, RYB, CMYG, or the like. A first pixel group, a second pixel group, and a third pixel group may be disposed to correspond to green, red, and blue color filters of the Bayer pattern, respectively. When the image sensor 100 includes a different type of color filter, a color filter having a highest sensitivity may be disposed to correspond to the first pixel group.

The photoelectric conversion element may be a photodiode PD. The photoelectric conversion element may be one of a photodiode PD, a photocapacitor, a photogate, a pinned photodiode PPD, a partially pinned photodiode, an organic photodiode OPD, a quantum dot QD, or any combination thereof.

Example embodiments are described with reference to an example in which the photoelectric conversion element is a photodiode PD, but other photoelectric conversion elements described above may be used in the image sensor 100. The photoelectric conversion element is not limited to a photodiode PD.

In an example embodiment, each of the plurality of pixels in each pixel group PG may include a pixel circuit for each individual pixel.

In an example embodiment, at least a portion of the plurality of pixels in each pixel group PG may share at least a portion of pixel circuits of the plurality of pixels.

For example, each pixel group PG may include a plurality of transistors controlled by the row driver 120. At least a portion of pixels in the same pixel group PG may share at least a portion of a driving transistor, a select transistor, and a reset transistor.

In an example embodiment, in an autofocusing mode, the pixel array 110 of the image sensor 100 may output a reset signal RSS and pixel signals PXS1 and PXS2 for each pixel or each pixel group PG through a column line CL. Each pixel group PG may include a plurality of pixels. According to an example embodiment, the pixel array 110 may either operate in the autofocusing mode when needed under control of the row driver 120, or may always operate in the autofocusing mode. Example embodiments are described with reference to an example in which the image sensor 100 operates in the autofocusing mode. However, example embodiments are not limited to always operating in the autofocusing mode.

In an example embodiment, the pixel array 110 may output a reset signal RSS and pixel signals PXS1 and PXS2 for each pixel in a full-pixel mode. In a binning mode, the pixel array 110 may output a reset signal RSS and pixel signals PXS1 and PXS2 for each pixel group PG. In an environment such as a preview mode and/or under low-illuminance condition, the pixel array 110 may operate in the binning mode under the control of the row driver 120.

The row driver 120 may drive a single row or a plurality of rows of the pixel array 110 under control of the timing controller 130. In the present specification, a “row” refers to a plurality of pixel groups PGs and/or pixels arranged in a first direction (for example, a horizontal direction) among the plurality of pixel groups PGs and/or a plurality of pixels of the pixel array 110. In addition, a “column” refers to a plurality of pixel groups PGs and/or pixels arranged in a second direction (for example, a vertical direction) among the plurality of pixel groups PGs and/or the plurality of pixels included in the pixel array 110.

The row driver 120 may drive at least one of the plurality of rows. The row driver 120 may generate a select signal to drive at least one of the plurality of rows. The row driver 120 may activate pixel groups PGs and/or pixels corresponding to a selected row. The reset signal RSS and pixel signals PXS1 and PXS2 of the pixel groups PGs and/or pixels of the selected row may be transmitted to the readout circuit 150 through a plurality of column output lines.

The pixel signals PXS1 and PXS2 may be based on a voltage of a floating diffusion region. Each of the pixel signals PXS1 and PXS2 may be based on a voltage reflecting charges generated by a photodiode(s) PD included in each pixel or each pixel group. The reset signal RSS may be a reference signal used to perform correlated double sampling (CDS). The reset signal RSS may be based on a voltage of the floating diffusion region reset by the reset transistor.

The timing controller 130 may control the pixel array 110, the row driver 120, the ramp signal generator 140, and the readout circuit 150. The timing controller 130 may provide a timing control signal TC to the row driver 120.

The timing control signal TC may be set differently based on an operating mode of the image sensor 100. For example, the image sensor 100 may operate in a per-pixel signal output mode or a per-pixel-group (PG) signal output mode. For example, the per-pixel-group (PG) signal output mode may be a binning mode in which pixel signals of pixels included in the same pixel group PG are combined and output.

The row driver 120 may drive each of the plurality of pixels and/or the plurality of pixel groups PGs in a normal imaging mode or a high dynamic range (HDR) mode based on the timing control signal TC.

The timing controller 130 may control the ramp signal generator 140 through a ramp control signal CS_RP. The ramp control signal CS_RP may include a ramp enable signal, a mode signal, or the like.

The ramp signal generator 140 may generate a ramp signal RAMP in response to the ramp control signal CS_RP. The ramp signal generator 140 may generate a ramp signal RAMP having a predetermined slope. The ramp signal generator 140 may provide the generated ramp signal RAMP to an analog-to-digital converter ADC of the readout circuit 150. The readout circuit 150 may include an analog-to-digital converter ADC.

The ADC of the readout circuit 150 may output an image signal IMG, which is a digital signal, based on the ramp signal RAMP and the pixel signal. For example, the ADC may output each of the pixel signals PXS as an image signal IMG based on the ramp signal RAMP using correlated double sampling. The image signal IMG may be provided to the image signal processing circuit 160. The image signal IMG may be an intensity value corresponding to the pixel signals PXS1 and PXS2. The readout circuit 150 may output a first image signal based on the first pixel signal PXS1 and a second image signal based on the second pixel signal PXS2. Accordingly, a magnitude of the first image signal may be smaller than that of the second image signal, which will be described in more detail later.

The image signal processing circuit 160 may process the image signal IMG received from the readout circuit 150 and transmit image data IDT to an external display device and/or an external storage device through an output interface.

In an example embodiment, when the image sensor 100 operates in an HDR mode, the row driver 120 may drive each of the plurality of pixels and/or pixel groups PGs to output the first and second pixel signals PXS1 and PXS2.

For example, the row driver 120 may control a pixel group PG such that a portion of the plurality of pixels in the pixel group PG output the first pixel signal PXS1 during a first readout period. The row driver 120 may control the pixel group PG such that all of the plurality of pixels in the pixel group PG output the second pixel signal PXS2 during a second readout period.

During the first readout period, some pixel groups PG among the plurality of pixel groups PGs may output a first pixel signal PXS1 having no phase information or at least reduced phase information based on some pixels included therein. During the first readout period, other pixel groups PG may output a first pixel signal PXS1 having phase information based on some pixels included therein.

For example, during the first readout period, a first pixel group may output a (1-1)-th pixel signal obtained by combining pixel signals of some pixels disposed at positions having opposing phase information in a certain direction with respect to a microlens. For example, pixel signals of some pixels included in the first pixel group and disposed at positions having opposing phase information in both horizontal and vertical directions may be combined. During the first readout period, second and third pixel groups may output a (1-2)-th pixel signal obtained by combining pixel signals of some pixels included in the second and third pixel groups and disposed at positions having the same phase information in a certain direction in the horizontal direction with respect to a microlens. Each pixel group may be disposed below the microlens. The microlens may be disposed above each of the plurality of pixel groups to overlap each of the plurality of pixel groups in a direction, perpendicular to a substrate of the image sensor 100.

During the second readout period, each of the pixel groups PGs may output a second pixel signal PXS2 obtained by combining pixel signals of all pixels among the plurality of pixels included in each pixel group.

In an example embodiment, the image signal processing circuit 160 may include an HDR processing circuit 161 and an autofocusing (AF) processing circuit 162.

The HDR processing circuit 161 may output HDR image data IDT using the image signal IMG.

In an example embodiment, the HDR processing circuit 161 may generate low-sensitivity image data based on the first image signal and high-sensitivity image data based on the second image signal. The HDR processing circuit 161 may generate HDR image data IDT using the low-sensitivity image data and the high-sensitivity image data.

In an example embodiment, when the second image signal reaches a saturation level, the HDR processing circuit 161 may generate high-sensitivity image data for some pixel groups PG, among the plurality of pixel groups PGs, using the first image signal.

For example, when the second image signal of the first pixel group PG reaches a saturation level, the HDR processing circuit 161 may generate high-sensitivity image data for the first pixel group PG using the first image signal of the first pixel group PG.

In an example embodiment, the HDR processing circuit 161 may determine whether the image signal IMG of a pixel group PG is saturated. When the image signal IMG of some pixel groups PG is saturated, the image signal processing circuit 160 may restore the saturated image signal IMG using an image signal IMG of an unsaturated pixel group PG.

For example, when the second image signal of the second pixel group is saturated, the HDR processing circuit 161 may generate the second image data of the second pixel group using the first image signal of the second pixel group and the first and second image signals of the third pixel group. In the present specification, restoring an image signal of a specific pixel group using the image signals of other pixel groups may be referred to as “color transferring.”

The AF processing circuit 162 may generate phase data. In an example embodiment, the phase data may be a phase difference signal PDS. The phase difference signal PDS may include a plurality of pieces of phase information obtained from positions having different phase information in a predetermined direction.

In an example embodiment, the AF processing circuit 162 may output a phase difference signal PDS. For example, the AF processing circuit 162 may output the phase difference signal PDS using different phase information in the horizontal direction. Example embodiments are described with reference to an example in which the phase difference signal PDS is output using difference pieces of phase information in the horizontal direction. However, example embodiments do not exclude outputting the phase difference signal PDS using different phase information in the vertical direction.

In an example embodiment, the AF processing circuit 162 may generate first phase information and second phase information based on the first image signal of the first pixel group, the first image signal of the second pixel group, and the first image signal of the third pixel group.

For example, the AF processing circuit 162 may generate the first phase information based on the first image signal of the second pixel group and the first image signal of the third pixel group. The AF processing circuit 162 may generate the second phase information using a value obtained by subtracting the first phase information from the first image signal of the first pixel group. The AF processing circuit 162 may output the first phase information and the second phase information as the phase difference signal PDS. According to an example embodiment, the AF processing circuit 162 may generate the second phase information using a value obtained by subtracting a multiple of the first phase information from the first image signal of the first pixel group.

Accordingly, the image sensor 100 may generate the phase difference signal PDS based on the first image signal of the first pixel group, the first image signal of the second pixel group, and the first image signal of the third pixel group to stably output the phase difference signal PDS across a wide illuminance range regardless of the saturation of the second image signal. For example, the phase difference signal PDS may be stably output until the first pixel signal, which is a low-sensitivity signal of the first pixel group, is saturated. As a result, an electronic device including the image sensor 100 may perform autofocusing stably.

For example, in the related art, when second image signals of all pixel groups PGs are saturated, the saturated second image signals may not be restored even using image signals of other pixel groups. As a result, phase difference information cannot be output.

FIGS. 2A to 2C are diagrams illustrating pixels according to example embodiments. The pixel array 110 of FIG. 1 may include pixel groups PG1, PG2, PG3 of FIGS. 2A to 2C. The pixel group PG according to example embodiments will be described with reference to FIGS. 1 and 2A to 2C. Example embodiments are not limited to the layouts of the pixel groups in FIGS. 2A to 2C and may include different types of pixel groups.

Each pixel group according to example embodiments may include a plurality of pixels disposed at positions having different phase information in the horizontal direction and a plurality of pixels disposed at positions having the same phase information in the horizontal direction.

The pixel groups PG1, PG2, and PG3 described with reference to FIGS. 2A to 2C are described with reference to an example in which they are arranged to correspond to a Bayer pattern color filter. However, the color pattern is not limited to a Bayer pattern color filter.

The image sensor may include a plurality of pixel groups, each including a plurality of pixels. Each of the plurality of pixels may include a photoelectric conversion element, which may be a photodiode. The plurality of pixels may share a microlens for every certain number of pixels.

Referring to FIGS. 2A to 2C, the pixel array 110 may include pixel units PU_A, PU_B, and PU_C. The pixel units PU_A, PU_B, and PU_C may be repeatedly arranged in a matrix within the pixel array 110.

Referring to FIGS. 2A to 2C, the pixel units PU_A, PU_B, and PU_C may include a first pixel group PG1, a second pixel group PG2, and a third pixel group PG3, respectively corresponding to the green, red, and blue color filters of a Bayer pattern. The pixel units PU_A, PU_B, and PU_C may include two first pixel groups PG1 based on the Bayer pattern.

Referring to FIG. 2A, each of the pixel groups PG1, PG2, and PG3 may include eight pixels, each pixel including a photoelectric conversion element such as a photodiode. The eight pixels may share a single microlens for every two pixels. For example, a first pixel PX1 and a second pixel PX2 of the first pixel group PG1 may share a first microlens ML1. A third pixel PX3 and a fourth pixel PX4 may share a second microlens ML2.

Referring to FIG. 2A, for example, the first pixel PX1 and the third pixel PX3 may be disposed at positions at which phase information in the horizontal direction thereof is the same with respect to different microlenses. The first pixel PX1 and the third pixel PX3 may be disposed at positions at which phase information in the horizontal direction thereof differs from that of the second pixel PX2 and the fourth pixel PX4. For example, the first pixel PX1 may be disposed at positions at which phase information in the horizontal direction of the first pixel PX1 differs from that of the second pixel PX2 and the fourth pixel PX4. The third pixel PX3 may be disposed at positions at which phase information in the horizontal direction of the third pixel PX3 differs from that of the second pixel PX2 and the fourth pixel PX4.

According an example embodiment, similarly to FIG. 2A, two pixels sharing a single microlens may be repeated within a single pixel group. A number of microlenses disposed within the single pixel group may be s× s or more, where s is a positive integer greater than or equal to 2.

Referring to FIG. 2B, each of the pixel groups PG1, PG2, and PG3 may include four pixels. Each of the four pixels may include a photoelectric conversion element such as a photodiode. The four pixels may share a single microlens. For example, the first pixel PX1, the second pixel PX2, the third pixel PX3, and the fourth pixel PX4 of the first pixel group PG1 may share a first microlens ML1.

Referring to FIG. 2B, for example, the first pixel PX1 and the third pixel PX3 may be disposed at positions at which the phase information in the horizontal direction thereof is the same with respect to the same microlens ML1. The first pixel PX1 and the third pixel PX3 may be disposed at positions at which the phase information in the horizontal direction thereof differs from that of the second pixel PX2 and the fourth pixel PX4 with respect to the same microlens ML1.

According to an example embodiment, similarly to FIG. 2B, all m×m pixels, where m is a positive integer greater than or equal to 2, disposed within a single pixel group may share a single microlens.

Referring to FIG. 2C, each of the pixel groups PG1, PG2, and PG3 may include 16 pixels. Each of the 16 pixels may include a photoelectric conversion element such as a photodiode. The 16 pixels may share a single microlens for every four pixels. For example, the first pixel PX1, the second pixel PX2, the third pixel PX3, and the fourth pixel PX4 of the first pixel group PG1 may share a first microlens ML1.

Referring to FIG. 2C, for example, the first pixel PX1, the third pixel PX3, and a fifth pixel PX5 may be disposed at positions at which phase information in the horizontal direction thereof is the same. The second pixel PX2, the fourth pixel PX4, and a sixth pixel PX6 may be disposed at positions at which phase information in the horizontal direction thereof is the same. Each of the first pixel PX1, the third pixel PX3, and the fifth pixel PX5 may be disposed at positions at which phase information in the horizontal direction thereof differs from that of the second pixel PX2, the fourth pixel PX4, and the sixth pixel PX6.

According to an example embodiment, similarly to FIG. 2C, k×k pixels, where k is a positive integer greater than or equal to 2, sharing a single microlens may be repeated within a single pixel group. A number of microlenses disposed within a single pixel group may be u×u or more, where u is a positive integer greater than or equal to 2.

Accordingly, some pixel groups may output a (1-1)-th pixel signal obtained by combining pixel signals of some pixels disposed at positions at which the phase information in the horizontal direction thereof is opposite to each other during the first readout period, while other pixel groups may output a (1-2)-th pixel signal obtained by combining pixel signals of some pixels disposed at positions at which phase information in the horizontal direction thereof is the same during the first readout period.

Each of the pixel groups may output a pixel signal obtained by combining pixel signals of all pixels within the individual pixel group during the second readout period.

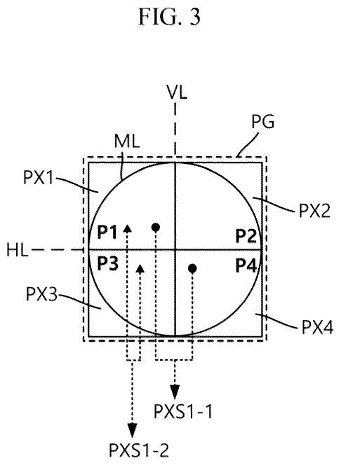

FIG. 3 is a diagram illustrating a first pixel signal of a pixel group according to an example embodiment. The embodiment of FIG. 3 is described using the pixel group of FIG. 2B as an example. However, the pixel group is not limited to the pixel groups of FIG. 2B and FIG. 3.

The pixel group PG according to an example embodiment may include a plurality of pixels disposed at positions with different phase information in a predetermined direction and other plurality of pixels disposed at positions with the same phase information in the predetermined direction.

For example, the pixel group PG may include four pixels PX1, PX2, PX3, and PX4 sharing the same microlens ML. The four pixels PX1, PX2, PX3, and PX4 may output pixel signals based on phase information P1, P2, P3, and P4, respectively.

The first pixel PX1 and the second pixel PX2 have different phase information in the horizontal direction, with respect to the microlens ML. For example, the first pixel PX1 and the second pixel PX2 are disposed at positions symmetrical to each other with respect to a virtual vertical central axis VL of the microlens ML. The first pixel PX1 and the third pixel PX3 have different phase information in the vertical direction, with respect to the microlens ML. For example, the first pixel PX1 and the third pixel PX3 are disposed at positions symmetrical to each other with respect to a virtual horizontal central axis HL of the microlens ML. The first pixel PX1 and the fourth pixel PX4 have different phase information in both the vertical and horizontal directions, with respect to the microlens ML. For example, the first pixel PX1 and the fourth pixel PX4 may be disposed at positions symmetrical to each other with respect to both the virtual horizontal central axis HL and the virtual vertical central axis VL of the microlens ML.

Some pixel groups may output a (1-1)-th pixel signal obtained by combining pixel signals of some pixels disposed at positions with opposing phase information in a predetermined direction during the first readout period, while other pixel groups may output a (1-2)-th pixel signal obtained by combining pixel signals of some pixels disposed at positions with the same phase information in the predetermined direction during the first readout period. An arrangement of pixels outputting the (1-1)-th pixel signal and an arrangement of pixels outputting the (1-2)-th pixel signal may differ from each other.

For example, when the pixel group PG outputs a (1-1)-th pixel signal PXS1-1, the pixel group PG may output a signal obtained by combining the pixel signals of the first pixel PX1 and the fourth pixel PX4 during the first readout period. Alternatively, the pixel group PG may output a signal obtained by combining the pixel signals of the second pixel PX2 and the third pixel PX3 during the first readout period. For example, the pixel group PG may combine and output the pixel signals of pixels disposed at positions with different phase information in both the horizontal and vertical directions.

When the pixel group PG outputs a (1-2)-th pixel signal PXS1-2, the pixel group PG may output a signal obtained by combining the pixel signals of the first pixel PX1 and the third pixel PX3 during the first readout period. Alternatively, the pixel group PG may output a signal obtained by combining the pixel signals of the second pixel PX2 and the fourth pixel PX4 during the first readout period. For example, the pixel group PG may combine and output the pixel signals of pixels disposed at positions with the same phase information in the horizontal direction.

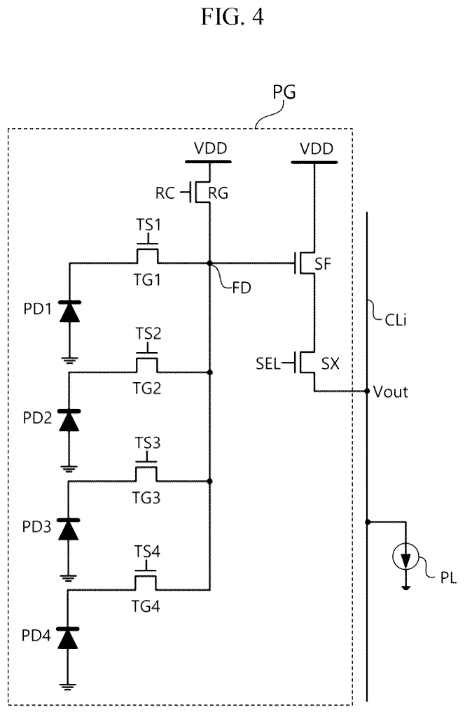

FIG. 4 is a circuit diagram of a pixel group PG according to an example embodiment. The circuit diagram of FIG. 4 may correspond to the pixel group PG of FIG. 3. The circuit diagram of the pixel group PG of FIG. 3 may be implemented in various circuit forms other than that of FIG. 4. The embodiment of FIG. 4 is described using the pixel group of FIG. 2B as an example. However, the pixel group is not limited to the pixel group of FIG. 2B.

The circuit diagram of the pixel group PG according to an example embodiment will be described with reference to FIGS. 3 and 4.

Referring to FIGS. 3 and 4, the pixel group PG may include a plurality of pixels PX1, PX2, PX3, and PX4. The plurality of pixels PX1, PX2, PX3, and PX4 may include photodiode PD1, PD2, PD3, and PD4, respectively.

The photodiodes PD1, PD2, PD3, and PD4 of the plurality of pixels PX1, PX2, PX3, and PX4 may be connected to a floating diffusion region FD through transfer transistors TG1, TG2, TG3, and TG4, respectively. The transfer transistors TG1, TG2, TG3, and TG4 may receive transfer control signals TS1, TS2, TS3, and TS4 from the row driver 120 of FIG. 1, respectively. The transfer transistors TG1, TG2, TG3, and TG4 may be turned on during the same time period or during different time periods. A portion of the transfer transistors TG1, TG2, TG3, and TG4 may be turned on during the same time period or during different time periods.

When the transfer transistors TG1, TG2, TG3, and TG4 are turned on during the same time period, pixel signals of all the plurality of pixels PX1, PX2, PX3, and PX4 may be combined and output as a pixel signal Vout through a column line CLi.

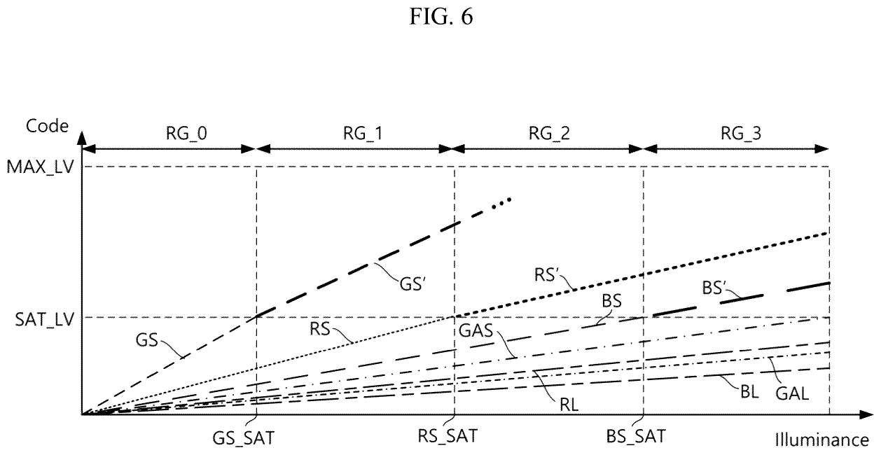

The plurality of pixels PX1, PX2, PX3, and PX4 may share at least some pixel circuits. For example, referring to FIG. 6, the plurality of pixels PX1, PX2, PX3, and PX4 may share a reset transistor RG, a driving transistor SF, and a select transistor SX. The reset transistor RG and the select transistor SX may receive a reset control signal RC and a select signal SEL, respectively, from the row driver 120 of FIG. 1.

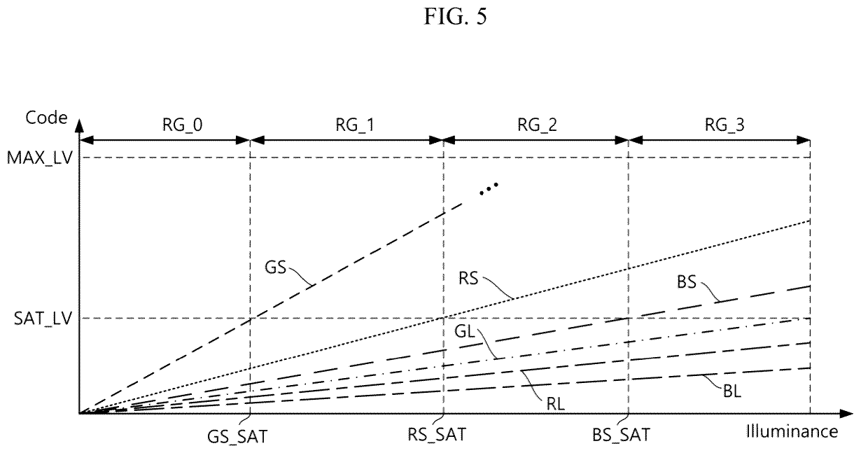

FIG. 5 is a diagram illustrating a change in an image signal according to a comparative example. The embodiment described with reference to FIG. 5 merely provides an alternatively selectable method and does not imply a known method.

FIG. 5 is described with reference to an example in which a pixel group corresponds to a Bayer pattern color filter. For example, a first pixel group, a second pixel group, and a third pixel group may be disposed to correspond to green, red, and blue color filters of the Bayer pattern, respectively. FIG. 5 illustrates examples of changes in image signals.

First image signals GL, RL, and BL may be generated based on first pixel signals of the first pixel group, the second pixel group, and the third pixel group according to the comparative example, respectively. The first pixel signals may be obtained by combining pixel signals of some pixels in the pixel group.

Second image signals GS, RS, and BS may be generated based on second pixel signals of the first pixel group, the second pixel group, and the third pixel group of the comparative example, respectively. The second pixel signals may be obtained by combining pixel signals of all pixels in the pixel group.

In the embodiment described with reference to FIG. 5, an image signal of a specific pixel group refers to an image signal generated based on the pixel signal(s) of the specific pixel group.

As illuminance changes, the second image signal GS of the first pixel group may reach a saturation level SAT_LV at a first illuminance level GS_SAT, followed by the second image signal RS of the second pixel group and the second image signal BS of the third pixel group reaching the saturation level SAT_LV at a second illuminance level RS_SAT and a third illuminance level BS_SAT, respectively. The saturation level SAT_LV may be a maximum value of a digital code set in the readout circuit. A maximum level MAX_LV may be a maximum value of the image signal used by the image signal processing circuit to generate an HDR image.

In a zeroth region RG_0, the illuminance does not reach the first illuminance level GS_SAT, and thus the second image signals GS, RS, and BS of the first pixel group, the second pixel group, and the third pixel group may not reach the saturation level SAT_LV. Therefore, the image sensor may normally output the first image signals GL, RL, and BL and the second image signals GS, RS, and BS. The image sensor may generate a phase difference signal based on the first image signals GL, RL, and BL and the second image signals GS, RS, and BS.

In the first region RG_1, the illuminance exceeds the first illuminance level GS_SAT and the second image signals RS and BS of the second pixel group and the third pixel group do not reach the saturation level SAT_LV, while the second image signal GS of the first pixel group may exceed the saturation level SAT_LV.

The image sensor may estimate a second image signal of a saturated pixel group using image signals of an unsaturated pixel group adjacent to the saturated pixel group. For example, the image sensor may consider estimation of the second image signal GS of the first pixel group using the first image signal GL of the first pixel group, the first image signals RL and BL of other pixel groups, and the second image signals RS and BS of other pixel groups. The image sensor may generate a phase difference signal of the first pixel group using the first image signal GL of the first pixel group and the estimated second image signal of the first pixel group. Phase difference signals of the second pixel group and the third pixel group may be generated in the same manner as in the zeroth region RG_0.

In the second region RG_2, similarly to the first region RG_1, the second image signals GS and RS of the first pixel group and the second pixel group exceed the saturation level SAT_LV, and the image sensor may estimate the second image signals GS and RS of the first pixel group and the second pixel group in a manner similar to that of the first region RG_1.

In the third region RG_3, the second image signals GS, RS, and BS of the first pixel group, the second pixel group, and the third pixel group may all exceed the saturation level SAT_LV. The second image signals GS, RS, and BS of the saturated pixel groups may not be estimated using image signals of adjacent unsaturated pixel groups.

When all the second image signals GS, RS, and BS are saturated, the image sensor may generate the second image signals GS, RS, and BS using the first image signals GL, RL, and BL of the first pixel group, the second pixel group, and the third pixel group, respectively. For example, the image sensor may generate the second image signals GS, RS, and BS by multiplying each of the first image signals GL, RL, and BL of the first pixel group by a factor of n.

Accordingly, in the third region RG_3, the first image signals GL, RL, and BL and the second image signals GS, RS, and BS have the same phase information, and the image sensor according to the comparative example is unable to generate a phase difference signal. The electronic device according to the comparative example is unable to accurately perform autofocusing.

FIG. 6 is a diagram illustrating image signals according to an example embodiment. Detailed descriptions of features identical or similar to those in the example embodiment of FIG. 5 are omitted to avoid redundancy. The image signals of FIG. 6 may be the image signals of the image sensor 100 of FIG. 1. The image signals of the image sensor 100 will be described with reference to FIGS. 1 and 6.

Among the pixel groups PGs of FIG. 1, the first pixel group may output a (1-1)-th pixel signal, obtained by summing (or combining) pixel signals of some pixels disposed at positions with opposing phase information in a predetermined direction, during the first readout period. The readout circuit 150 may digitally convert the (1-1)-th pixel signal to output a first image signal GAS.

Each of the second pixel group and the third pixel group may output a (1-2)-th pixel signal, obtained by summing pixel signals of some pixels disposed at positions with the same phase information in the predetermined direction, during the first readout period. The readout circuit 150 may digitally convert the (1-2)-th pixel signal to output second image signals RL and BL.

Among the pixel groups PGs of FIG. 1, the first pixel group may output a second pixel signal, obtained by summing pixel signals of all pixels within the pixel group PG, during the second readout period. The readout circuit 150 may digitally convert the second pixel signal to output a second image signal GS.

The image signal processing circuit 160 of FIG. 1 may generate a second pseudo-image signal GS′, obtained by amplifying the first image signal GAS by a factor of n, in the first region RG_1 to the third region RG_3 in which the second image signal GS of the first pixel group reaches the saturation level SAT_LV. The amplification factor n may be a sensitivity ratio between low-sensitivity image data and high-sensitivity image data used to generate an HDR image. The image signal processing circuit 160 may use the first image signal GAS and the second pseudo-image signal GS' to generate an HDR image.

The image signal processing circuit 160 of FIG. 1 may generate second pseudo-image signals RS' and BS' of the second pixel group and the third pixel group using the image signals of surrounding unsaturated pixel groups when one of the second image signals RS and BS of the second pixel group and the third pixel group reaches the saturation level SAT_LV.

For example, the image signal processing circuit 160 may generate the second pseudo-image signals RS' and BS' of the second pixel group and the third pixel group in the first region RG_1 and the second region RG_2, based on Equation 1. The image signal processing circuit 160 may generate an HDR image using the first image signals RL and BL and the second pseudo-image signals RS' and BS' of the second pixel group and the third pixel group in the first region RG_1 and the second region RG_2.

RS′=(BS/BL)×RL

BS′=(RS/RL)×BL Equation 1

Referring to Equation 1, when the second image signal RS of the second pixel group is saturated, the second pseudo-image signal RS' of the second pixel group may be generated by dividing the second image signal BS of the surrounding unsaturated third pixel group by the first image signal BL of the third pixel group and then multiplying the result by the first image signal RL of the second pixel group.

Similarly, when the second image signal BS of the third pixel group is saturated, the second pseudo-image signal BS' of the third pixel group may be generated by dividing the second image signal RS of the surrounding unsaturated second pixel group by the first image signal RL of the second pixel group and then multiplying the result by the first image signal BL of the third pixel group.

The image signal processing circuit 160 of FIG. 1 may generate the second pseudo-image signals RS' and BS' of the second pixel group and the third pixel group using the first image signal GAS and a first pseudo-image signal GAL of the first pixel group and the first image signals RL and BL of the second pixel group and the third pixel group when both of the second image signals RS and BS of the second pixel group and the third pixel group reach the saturation level SAT_LV (for example, in the third region RG_3).

For example, the image signal processing circuit 160 may generate the second pseudo-image signals RS' and BS' of the second pixel group and the third pixel group in the third region RG_3, based on Equation 2. The image signal processing circuit 160 may generate an HDR image using the first image signals RL and BL and the second pseudo-image signals RS' and BS' of the second pixel group and the third pixel group in the third region RG_3.

RS′=(RL/GAL)×(GAS×n)

BS′=(BL/GAL)×(GAS×n) Equation 2

Referring to Equation 2, in the third region RG_3, the second pseudo-image signal RS' of the second pixel group may be generated by dividing the first image signal RL of the second pixel group by the first pseudo-image signal GAL of the first pixel group and then multiplying the result by the first image signal GAS of the first pixel group and the factor of n.

Similarly, in the third region RG_3, the second pseudo-image signal BS' of the third pixel group may be generated by dividing the first image signal BL of the third pixel group by the first pseudo-image signal GAL of the first pixel group and then multiplying the result by the first image signal GAS of the first pixel group and the factor of n.

In Equation 2, n may be a sensitivity ratio between low-sensitivity image data and high-sensitivity image data used to generate an HDR image.

The image sensor 100 may generate the first pseudo-image signal GAL of the first pixel group based on Equation 3.

GAL=(RL×wbR+BL×wbB)/4 Equation 3

Referring to Equation 3, the first pseudo-image signal GAL of the first pixel group may be generated by adding a first value, obtained by multiplying the first image signal RL of the second pixel group by a first white balance gain wbR, and a second value, obtained by multiplying the first image signal BL of the third pixel group by a second white balance gain wbB, and then dividing the sum by 4. The first image signal GAS may be based on pixel signals of two pixels. The first pseudo-image signal GAL of the first pixel group may be generated as a value, obtained by dividing the sum of the first value and the second value by 4, to generate phase information from the first image signal GAS and the first pseudo-image signal GAL.

The image sensor may generate a phase difference signal using the first pseudo-image signal GAL of the first pixel group and the first image signal GAS of the first pixel group. A first white balance gain and a second white balance gain may be received from a host device. For example, the first white balance gain and the second white balance gain may be received from an application processor of an electronic device.

In an example embodiment, the image sensor 100 may regard the first image signal GAS based on the first pixel signal of the first pixel group with phase information removed, as a merged second image signal of the first pixel group. The image sensor 100 may generate the first pseudo-image signal GAL of the first pixel group based on the first pixel signals of the second pixel group and the third pixel group, which retain phase information. Thus, the first pseudo-image signal GAL may be generated as the first phase information, and a value obtained by subtracting the first phase information first pseudo-image signal GAL from the first image signal GAS may be generated as the second phase information. The image sensor 100 may output the first phase information and the second phase information as a phase difference signal.

In all regions RG_0, RG_1, RG_2, and RG_3, the first image signal GAS of the first pixel group may not be saturated. Additionally, in all regions RG_0, RG_1, RG_2, and RG_3, the first image signal RL of the second pixel group and the first image signal BL of the third pixel group may not be saturated. Accordingly, the image sensor 100 may stably generate a phase difference signal in the regions RG_0, RG_1, RG_2, and RG_3 until the first image signal GAS of the first pixel group is saturated.

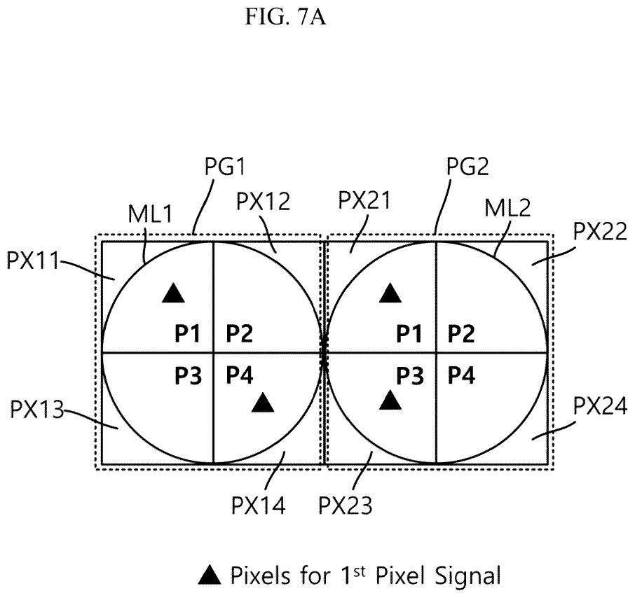

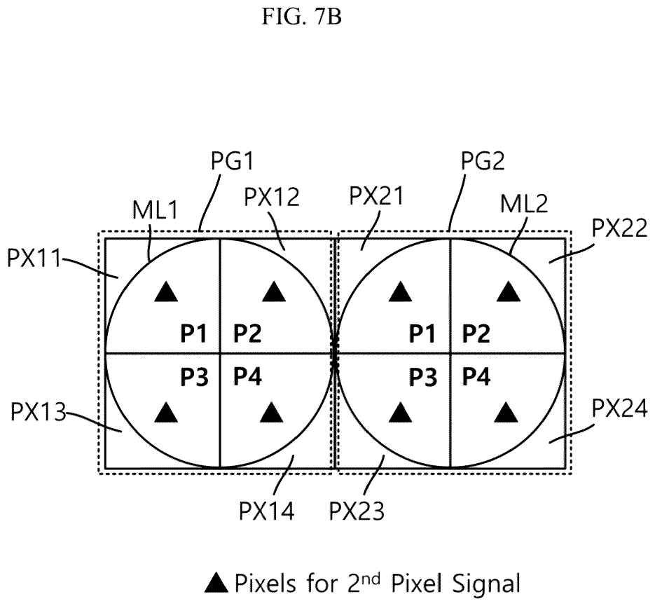

FIGS. 7A and 7B are diagrams illustrating pixel signals according to an example embodiment. FIG. 7A is a diagram illustrating first pixel signals of a first pixel group and a second pixel group, and FIG. 7B is a diagram illustrating second pixel signals of the first pixel group and the second pixel group.

The embodiments of FIGS. 7A and 7B are described using the pixel group of FIG. 2B as an example. However, the pixel group is not limited to the pixel groups of FIG. 2B, FIG. 7A, and FIG. 7B.

FIGS. 7A and 7B illustrate the pixel signals of the first pixel group and the second pixel group described with reference to FIGS. 2 and 6. Pixel signals of the third pixel group may be similar to those of the second pixel group.

In an example embodiment, during the first readout period, the first pixel group PG1 may output a (1-1)-th pixel signal with phase information removed or reduced and the second pixel group PG2 may output a (1-2)-th pixel signal with phase information preserved, during the first readout operation.

For example, referring to FIG. 7A, the first pixel group PG1 may combine and output pixel signals of a first pixel PX11 and a fourth pixel PX14, which are pixels with opposite phase information in both horizontal and vertical directions with respect to a first microlens ML1, during the first readout period. The second pixel group PG2 may combine and output pixel signals of a first pixel PX21 and a third pixel PX23, which are pixels with the same phase information in the horizontal direction with respect to the second microlens ML2.

In an example embodiment, the first pixel group PG1 and the second pixel group PG2 may output a second pixel signal, obtained by combining pixel signals of all pixels within the pixel group, during a second readout period.

For example, referring to FIG. 7B, the first pixel group PG1 may combine and output pixel signals of all pixels PX11, PX12, PX13, and PX14 and the second pixel group PG2 may combine and output pixel signals of all pixels PX21, PX22, PX23, and PX24, during the second readout period.

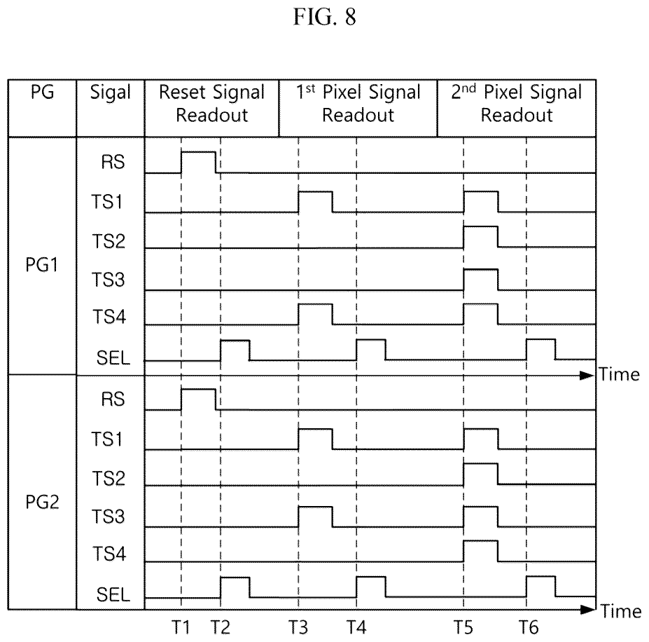

FIG. 8 is a timing diagram of control signals provided to the pixel groups PG1 and PG2 according to the embodiments of FIGS. 7A and 7B. In an example embodiment, the circuit diagram of the pixel groups PG1 and PG2 in FIG. 8 may be similar to the circuit diagram of FIG. 4. The operation of the pixel groups PG1 and PG2 will be described with reference to FIGS. 4, 7A, 7B, and 8.

At a first time T1, the reset control signal RC of the first pixel group PG1 and the second pixel group PG2 may transition to a high level, and a reset transistor RG may reset a floating diffusion region FD.

At a second time T2, the select signal SEL of the first pixel group PG1 and the second pixel group PG2 may transition to a high level, and the select transistor SX may output a voltage of the reset floating diffusion region FD as a reset signal.

At a third time T3, the first transfer control signal TS1 and the fourth transfer control signal TS4 of the first pixel group PG1 may transition to a high level, and the first transfer transistor TG1 and the fourth transfer transistor TG4 may transfer the photocharges of the first pixel PX11 and the fourth pixel PX14 to the floating diffusion region FD. The first pixel PX11 and the fourth pixel PX14 may have opposite phase information in both the horizontal and vertical directions with respect to the first microlens ML1, as described in the embodiment with reference to FIG. 7A, while example embodiments are not limited thereto. At a fourth time T4, the select transistor SX of the first pixel group PG1 may be turned on again, and a (1-1)-th pixel signal based on the photocharges of both the first pixel PX11 and the fourth pixel PX14 may be output.

At the third time T3, the first transfer control signal TS1 and the third transfer control signal TS3 of the second pixel group PG2 may transition to a high level, and the first transfer transistor TG1 and the third transfer transistor TG3 may transfer the photocharges of the first pixel PX21 and the third pixel PX23 to the floating diffusion region FD. The first pixel PX21 and the third pixel PX23 may have the same phase information in the horizontal direction with respect to the first microlens ML1, as described in the embodiment with reference to FIG. 7A. At the fourth time T4, the select transistor SX of the second pixel group PG2 may be turned on again, and a (1-2)-th pixel signal based on the photocharges of both the first pixel PX21 and the third pixel PX23 may be output.

At a fifth time T5, all the transfer control signals TS1, TS2, TS3, and TS4 of the first pixel group PG1 may transition to a high level, and the transfer transistors TG1, TG2, TG3, and TG4 of the first pixel group PG1 may transfer photocharges of the pixels PX11, PX12, PX13, and PX14 to the floating diffusion region FD. Similarly, all the transfer control signals TS1, TS2, TS3, and TS4 of the second pixel group PG2 may transition to a high level, and the transfer transistors TG1, TG2, TG3, and TG4 of the second pixel group PG2 may transfer photocharges of the pixels PX21, PX22, PX23, and PX24 to the floating diffusion region FD.

At a sixth time T6, the select transistors SX of the first pixel group PG1 and the second pixel group PG2 may be turned on again by the select signal SEL, and each of the first pixel group PG1 and the second pixel group PG2 may output the second pixel signal.

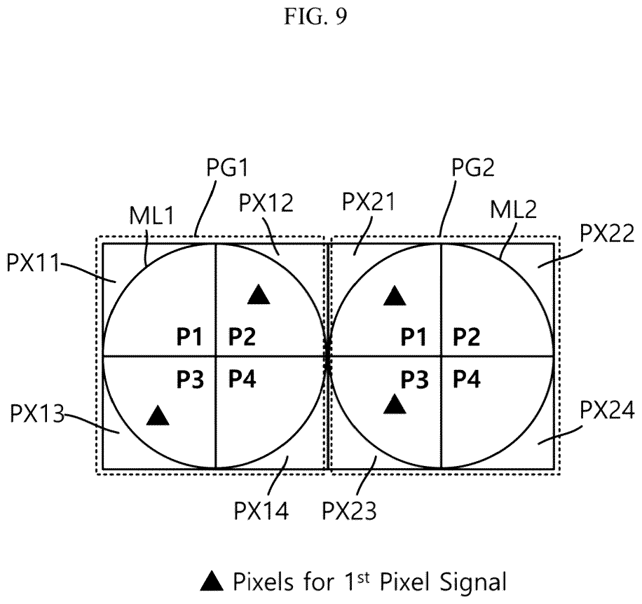

FIG. 9 is a diagram illustrating first pixel signals of a first pixel group PG1 and a second pixel group PG2 according to an example embodiment. The embodiment of FIG. 9 is described using the pixel group of FIG. 2B as an example. However, the pixel group is not limited to the pixel groups of FIG. 2B and FIG. 9.

The first pixel signals of the first pixel group PG1 and the second pixel group PG2 will be described with reference to FIG. 9. Detailed descriptions of features identical or similar to those in the example embodiment of FIGS. 7A and 7B are omitted to avoid redundancy. Pixel signals of the third pixel group may be similar to those of the second pixel group.

Referring to FIG. 9, the first pixel group PG1 may combine and output pixel signals of the second pixel PX12 and the third pixel PX13, which are pixels with opposite phase information with respect to the first microlens ML1, during a first readout period. The pixel signals of the second pixel PX12 and the third pixel PX13 may have opposite phase information in both horizontal and vertical directions with respect to the first microlens ML1.

The second pixel group PG2 may combine and output pixel signals of the first pixel PX21 and the third pixel PX23, which are pixels with the same phase information in the horizontal direction with respect to the second microlens ML2.

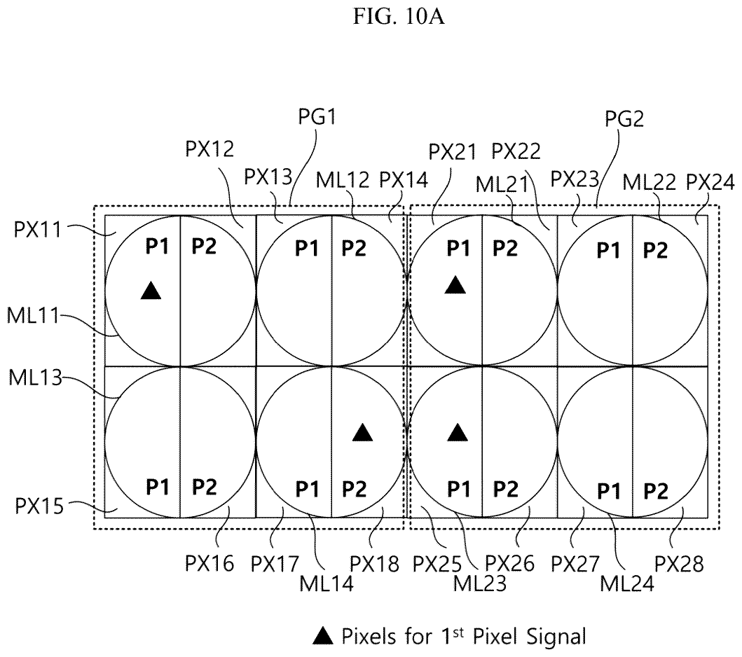

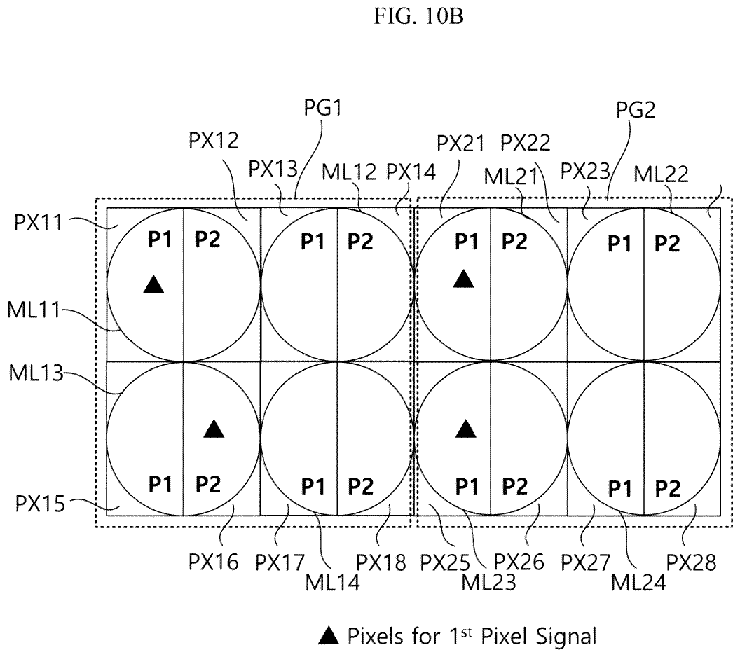

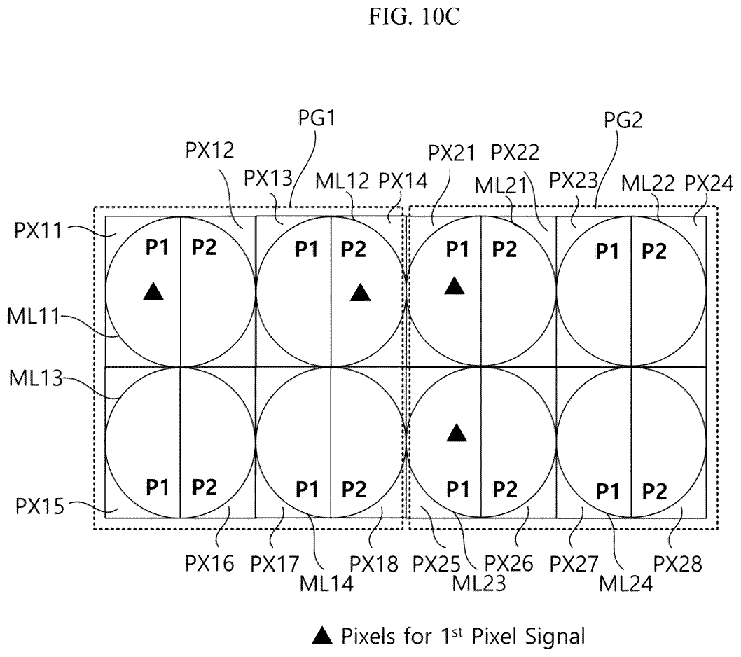

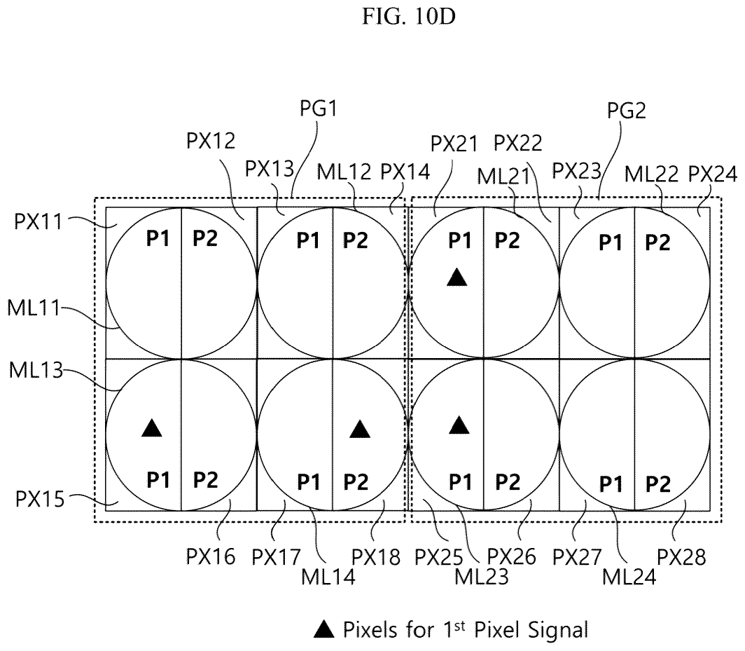

FIGS. 10A to 10D are diagrams illustrating first pixel signals of a first pixel group PG1 and a second pixel group PG2 according to example embodiments. The embodiments of FIGS. 10A to 10D are described using the pixel group of FIG. 2A as an example. However, the pixel group is not limited to the pixel groups of FIG. 2A and FIGS. 10A to 10D.

The first pixel signals of the first pixel group PG1 and the second pixel group PG2 will be described with reference to FIGS. 10A to 10D. Detailed descriptions of features identical or similar to those in the example embodiment of FIGS. 2A to 2C, 7A, 7B, and 9 are omitted to avoid redundancy. The pixel signals of the third pixel group may be similar to those of the second pixel group.

Pixel groups in FIGS. 10A to 10D may each include eight pixels. Each of the eight pixels may include a photoelectric conversion element such as a photodiode. The eight pixels may share a single microlens for every two pixels. Two pixels, sharing a microlens, may be disposed adjacent to each other in the horizontal direction. All the pixels in the pixel groups of FIGS. 10A to 10D have the same phase information in the vertical direction.

The second pixel group PG2 in FIGS. 10A to 10D may combine and output the pixel signals of a first pixel PX21 and a fifth pixel PX25, which are pixels with the same phase information in the horizontal direction with respect to second microlenses ML21, ML23. Alternatively, the second pixel group PG2 may combine and output the pixel signals of ta third pixel PX23 and a seventh pixel PX27, which are pixels with the same phase information in the horizontal direction with respect to the second microlenses ML21, ML23. Alternatively, the second pixel group PG2 may combine and output the pixel signals of a second pixel PX22 and a sixth pixel PX26, or combine and output the pixel signals of a fourth pixel PX24 and an eighth pixel PX28.

Referring to FIG. 10A, the first pixel group PG1 may combine and output pixel signals of a first pixel PX11 and an eighth pixel PX18, which are pixels with opposite phase information in the horizontal direction with respect to first microlenses ML11, ML14, during a first readout period. The first pixel PX11 and the eighth pixel PX18 may have the same phase information in the vertical direction. Positions of the first pixel PX11 and the eighth pixel PX18 within the first pixel group PG1 may be symmetrical in both the horizontal and vertical directions. For example, when the first pixel group PG1 is viewed in a direction perpendicular to a substrate, the first pixel PX11 may be disposed at an upper left corner of the first pixel group PG1 and the eighth pixel PX18 may be disposed at a lower right corner of the first pixel group PG1.

In an example embodiment, unlike the illustration in FIG. 10A, the first pixel group PG1 may combine and output pixel signals of a fourth pixel PX14 and a fifth pixel PX15, which are pixels with opposite phase information in the horizontal direction with respect to the first microlenses ML11, ML14, during the first readout period. Positions of the fourth pixel PX14 and the fifth pixel PX15 within the first pixel group PG1 may be symmetrical in both the horizontal and vertical directions.

Referring to FIG. 10B, the first pixel group PG1 may combine and output pixel signals of the first pixel PX11 and a sixth pixel PX16, which are pixels with opposite phase information in the horizontal direction with respect to first microlenses ML11, ML13, during a first readout period. Positions of the first pixel PX11 and the sixth pixel PX16 within the first pixel group PG1 may not be symmetrical in horizontal and vertical directions.

Referring to FIG. 10C, the first pixel group PG1 may combine and output pixel signals of the first pixel PX11 and the fourth pixel PX14, which are pixels with opposite phase information in the horizontal direction with respect to first microlens ML11, ML12, during a first readout period. Positions of the first pixel PX11 and the fourth pixel PX14 within the first pixel group PG1 may be symmetrical in the horizontal direction but asymmetrical in the vertical direction. For example, the first pixel PX11 may be disposed at an upper left corner of the first pixel group PG1, and the fourth pixel PX14 may be disposed at an upper right corner of the first pixel group PG1.

Referring to FIG. 10D, the first pixel group PG1 may combine and output pixel signals of the fifth pixel PX15 and the eighth pixel PX18, which are pixels with opposite phase information in the horizontal direction with respect to first microlens ML13, ML14, during a first readout period. Positions of the fifth pixel PX15 and the eighth pixel PX18 within the first pixel group PG1 may be symmetrical in the horizontal direction but asymmetrical in the vertical direction. For example, the fifth pixel PX15 may be disposed at a lower left corner of the first pixel group PG1, and the eighth pixel PX18 may be disposed at a lower right corner of the first pixel group PG1.

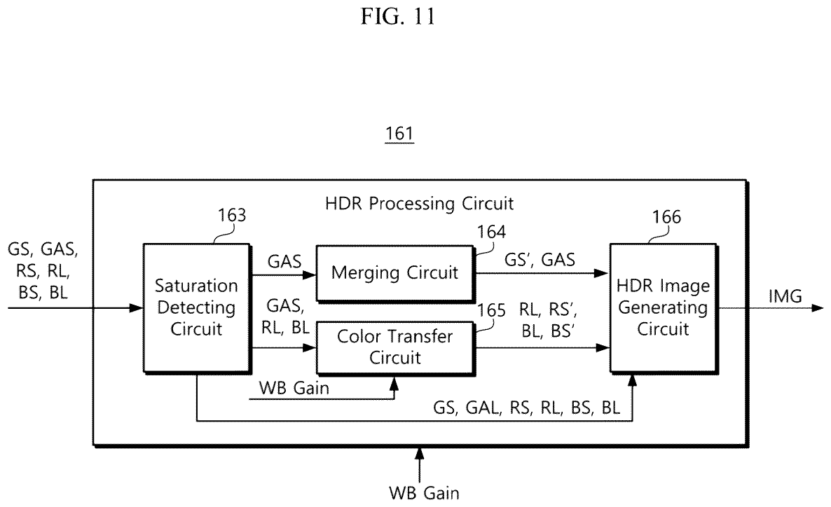

FIG. 11 is a block diagram illustrating a configuration of an HDR processing circuit 161 of an image signal processing circuit according to an example embodiment. The HDR processing circuit 161 of FIG. 11 may correspond to the HDR processing circuit 161 of FIG. 1. The HDR processing circuit 161 will be described with reference to FIGS. 1, 6, and 11.

Referring to FIG. 11, the HDR processing circuit 161 may include a saturation detecting circuit 163, a merging circuit 164, a color transfer circuit 165, and an HDR image generating circuit 166.

The saturation detecting circuit 163 may receive a first image signal GAS and a second image signal GS of a first pixel group PG1, a first image signal RL and a second image signal RS of a second pixel group PG2, and a first image signal BL and a second image signal BS of a third pixel group PG3 from the readout circuit 150 of FIG. 1.

In an example embodiment, the saturation detecting circuit 163 may determine whether the second image signals GS, RS, and BS of the pixel groups PG1, PG2, and PG3 are saturated. When none of the second image signals GS, RS, and BS are saturated, the HDR image generating circuit 166 may generate HDR image data IMG using the first image signals GAS, RL, and BL and the second image signals GS, RS, and BS of the pixel groups PG1, PG2, and PG3.

When the second image signal GS of the first pixel group PG1 is saturated, the saturation detecting circuit 163 may transmit the first image signal GAS of the first pixel group PG1 to the merging circuit 164. The merging circuit 164 may transmit a second pseudo-image signal GS′, obtained by amplifying the first image signal GAS of the first pixel group PG1 by a factor of n, to the HDR image generating circuit 166.

When one of the second image signals RS and BS of the second pixel group PG2 and the third pixel group PG3 is saturated, the saturation detecting circuit 163 may transmit the first image signal GAS of the first pixel group PG1 and the first image signals RL and BL of the second pixel group PG2 and the third pixel group PG3 to the color transfer circuit 165.

When one of the second image signals RS and BS of the second pixel group PG2 and the third pixel group PG3 is saturated, the color transfer circuit 165 may estimate second pseudo-image signals RS' and BS' of the second pixel group PG2 and the third pixel group PG3 based on Equation 1 described with reference to FIG. 6.

When the second image signals RS and BS of both the second pixel group PG2 and the third pixel group PG3 are saturated, the color transfer circuit 165 may estimate the second pseudo-image signals RS' and BS' of both the second pixel group PG2 and the third pixel group PG3 based on Equation 2 and Equation 3 described with reference to FIG. 6. The color transfer circuit 165 may use a white balance gain WB Gain, received from a host device, to estimate the first pseudo-image signal GAL of the first pixel group PG1. The color transfer circuit 165 may transmit the second pseudo-image signals RS' and BS′, along with the first image signals RL and BL, to the HDR image generating circuit 166.

The HDR image generating circuit 166 may generate HDR image data IMG using the received signals.

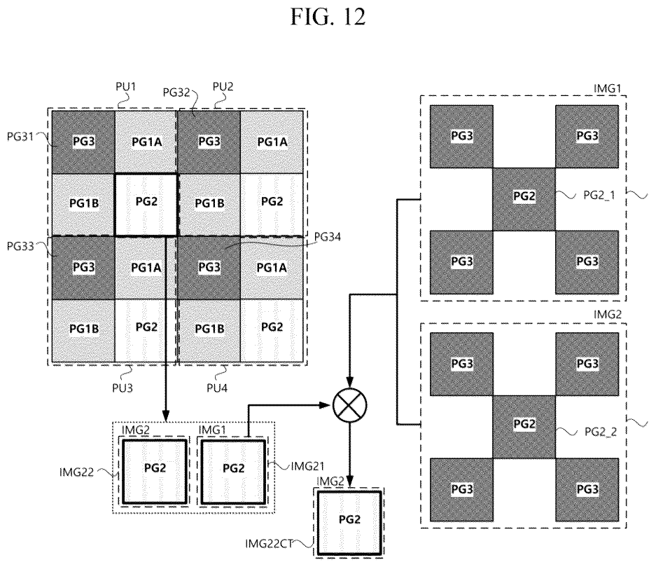

FIG. 12 is a diagram illustrating a color transfer operation of the HDR processing circuit 161 of FIG. 11 according to an example embodiment. The color transfer operation of the HDR processing circuit 161 will be described with reference to FIGS. 11 and 12. For example, the color transfer operation according to an example embodiment of FIG. 12 may be performed based on Equation 1 when the second image signal RS of the second pixel group PG2 in a first region RG1 and a second region RG2 of FIG. 6 is saturated.

FIG. 12 illustrates four pixel units PU1, PU2, PU3, and PU4. Referring to FIG. 12, each of the pixel units PU1, PU2, PU3, and PU4 may include two first pixel groups PG1A and PG1B, a second pixel group PG2, and a third pixel group PG3.

The HDR processing circuit 161 may determine that a second image signal IMG22 of the second pixel group PG2 is saturated. For example, the second image signal IMG22 of the second pixel group PG2 in the first pixel unit PU1 may be saturated.

The HDR processing circuit 161 may restore a second image signal IMG22 of the second pixel group PG2 in the first pixel unit PU1 using image signals of the third pixel groups PG31, PG32, PG33, and PG34 (or collectively PG3) surrounding the second pixel group PG2 within the first pixel unit PU1 and a first image signal IMG21 of the second pixel group PG2 in the first pixel unit PU1.

For example, the HDR processing circuit 161 may interpolate first image signals CT1 of the third pixel groups PG31, PG32, PG33, and PG34 to generate a first image signal PG2_1 corresponding to a position of the second pixel group PG2 in the first pixel unit PU1. Additionally, the HDR processing circuit 161 may interpolate second image signals CT2 of the third pixel groups PG31, PG32, PG33, and PG34 to generate a second image signal PG2_2 corresponding to the position of the second pixel group PG2 in the first pixel unit PU1.

The HDR processing circuit 161 may generate a restored second image signal IMG22CT of the second pixel group PG2 in the first pixel unit PU1 by applying Equation 1 to the first image signal PG2_1 corresponding to the position of the second pixel group PG2 in the first pixel unit PU1, the second image signal PG2_2 corresponding to the position of the second pixel group PG2 in the first pixel unit PU1, and the first image signal IMG21 of the second pixel group PG2 in the first pixel unit PU1.

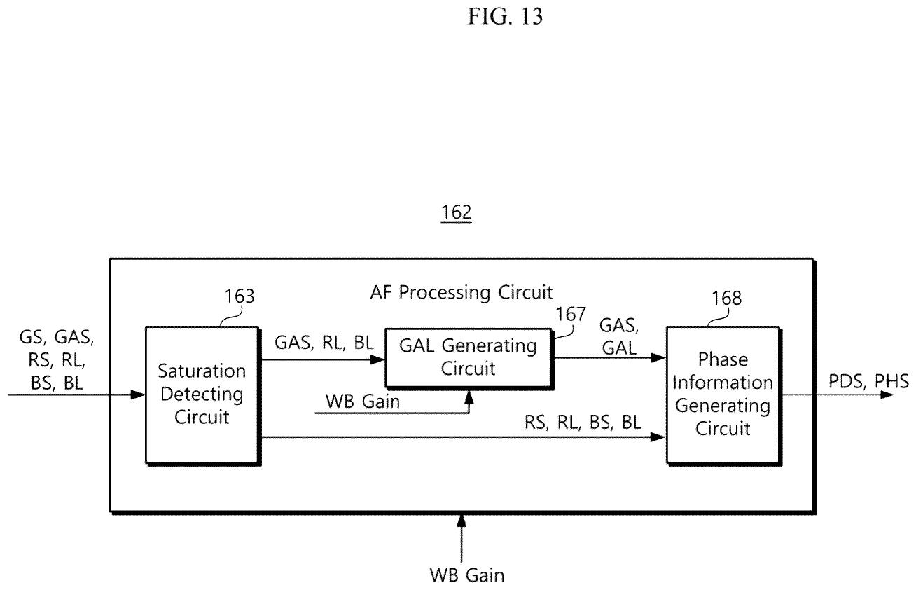

FIG. 13 is a block diagram illustrating a configuration of an AF processing circuit 162 of an image signal processing circuit according to an example embodiment. The AF processing circuit 162 of FIG. 13 may correspond to the AF processing circuit 162 of FIG. 1. The AF processing circuit 162 will be described with reference to FIGS. 1, 6, and 13.

Referring to FIG. 13, the AF processing circuit 162 may include a saturation detecting circuit 163, a first pseudo-image signal (GAL) generating circuit 167, and a phase information generating circuit 168.

The saturation detecting circuit 163 may receive the first image signal GAS and the second image signal GS of the first pixel group PG1, the first image signal RL and the second image signal RS of the second pixel group PG2, and the first image signal BL and the second image signal BS of the third pixel group PG3 from the readout circuit 150 of FIG. 1.

The first image signal GAS of the first pixel group PG1 may be based on first pixel signals of some pixels disposed at positions with opposite phase information. The first image signal RL of the second pixel group PG2 and the first image signal BL of the third pixel group PG3 may be based on the first pixel signals of some pixels disposed at positions with the same phase information.

In an example embodiment, the saturation detecting circuit 163 may determine whether any one of the second image signals GS, RS, and BS of the pixel groups PG1, PG2, and PG3 are saturated.

When at least one of the second image signals RS and BS of the second pixel group PG2 and the third pixel group PG3 is not saturated, the saturation detecting circuit 163 may transmit a first image signal and a second image signal of the unsaturated pixel group to the phase information generating circuit 168. For example, when the second image signal BS of the third pixel group PG3 is not saturated, the saturation detecting circuit 163 may transmit the first image signal BL and the second image signal BS of the third pixel group PG3 to the phase information generating circuit 168.

The saturation detecting circuit 163 may transmit a first pseudo-image signal GAL of the first pixel group PG1, the first image signal RL of the second pixel group PG2, and the first image signal BL of the third pixel group PG3 to the first pseudo-image signal generating circuit 167.

The first pseudo-image signal generating circuit 167 may generate the first pseudo-image signal GAL of the first pixel group by applying Equation 3 to a white balance gain WB Gain and the first image signals GAL, RL, and BL of the pixel groups PG1, PG2, and PG3. The first pseudo-image signal generating circuit 167 may transmit the first pseudo-image signal GAL and the first image signal GAS of the first pixel group to the phase information generating circuit 168.

The phase information generating circuit 168 may generate phase data based on the first pseudo-image signal GAL and the first image signal GAS of the first pixel group. For example, the phase information generating circuit 168 may generate a phase difference signal PDS, including first phase information and second phase information, as phase data. The phase information generating circuit 168 may generate the first image signal GAS of the first pixel group as first phase information. The phase information generating circuit 168 may generate a value, obtained by subtracting the first pseudo-image signal GAL from the first image signal GAS of the first pixel group, as second phase information.

When at least one of the second image signals RS and BS of the second pixel group PG2 and the third pixel group PG3 is not saturated, the phase information generating circuit 168 may generate an additional phase difference signal PHS using a first image signal and a second image signal of the unsaturated pixel group. For example, when the second image signal BS of the third pixel group PG3 is not saturated, the phase information generating circuit 168 may generate the first image signal BL of the third pixel group PG3 as first phase information and a difference between the second image signal BS and the first image signal BL as second phase information.

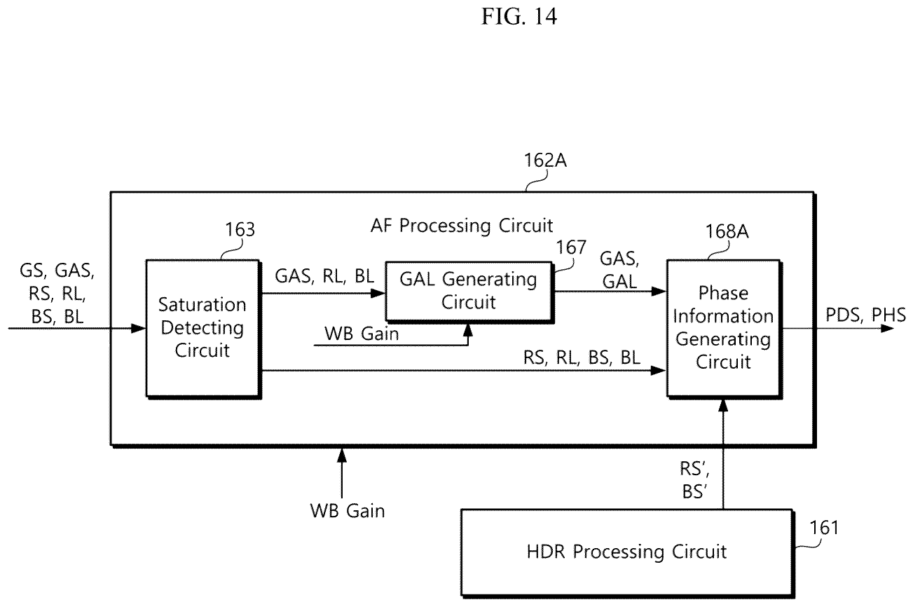

FIG. 14 is a block diagram illustrating a configuration of an AF processing circuit 162A of an image signal processing circuit according to an example embodiment. The AF processing circuit 162A of FIG. 14 may correspond to the AF processing circuit 162 of FIG. 1. The AF processing circuit 162A will be described with reference to FIGS. 1, 6, and 14, while focusing on the differences from the AF processing circuit 162 described with reference to FIG. 13.

Referring to FIG. 14, unlike the AF processing circuit 162 of FIG. 13, the AF processing circuit 162A may receive a second pseudo-image signal RS' of the second pixel group PG2 and a third pseudo-image signal BS' of the third pixel group PG3 from the HDR processing circuit 161.

When at least one of the second image signals RS and BS of the second pixel group PG2 and the third pixel group PG3 is not saturated, the AF processing circuit 162A may generate an additional phase difference signal PHS using a first image signal and a second image signal of the unsaturated pixel group.

When at least one of the second image signals RS and BS of the second pixel group PG2 and the third pixel group PG3 is saturated, the AF processing circuit 162A may generate an additional phase difference signal PHS using a first image signal and a second pseudo-image signal of the saturated pixel group.

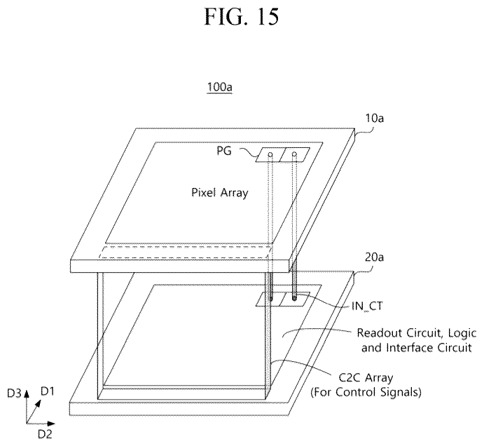

FIG. 15 is a block diagram of an image sensor 100a according to an example embodiment. Detailed descriptions of features identical or similar to those in the previous embodiments are omitted to avoid redundancy. A pixel group PG of FIG. 15 may correspond to the pixel group PG of FIG. 1.

The image sensor 100a may include a first substrate 10a and a second substrate 20a, which are stacked. The first substrate 10a and the second substrate 20a may be connected to each other through a wafer bonding process using a copper-to-copper (C2C) interconnection at a pixel group level. The first substrate 10a and the second substrate 20a may be electrically connected not only through an in-pixel contacts IN_CT within the pixel group PG but also through a C2C array disposed in a peripheral region of a substrate. Control signals for controlling the pixel circuits may be transmitted through the C2C array. Pixel signals from the first substrate 10a may be transmitted to a readout circuit of the second substrate 20a through the in-pixel contacts IN_CT.

In an example embodiment, some pixel circuits may be disposed on the first substrate 10a, while other pixel circuits may be disposed on the second substrate 20a.

In an example embodiment, all the pixel circuits may be disposed on the second substrate 20a.

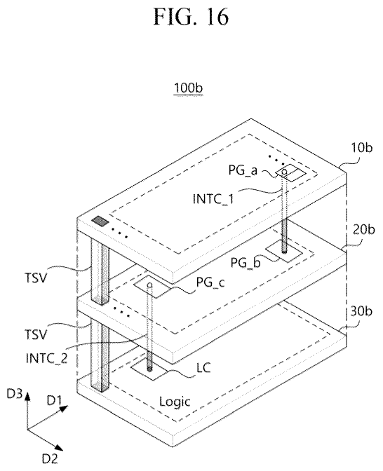

FIG. 16 is a block diagram of an image sensor 100b according to an example embodiment. Detailed descriptions of features identical or similar to those in the previous embodiments are omitted to avoid redundancy. A pixel group PG of FIG. 16 may correspond to the pixel group PG of FIG. 1.

Referring to FIG. 16, the image sensor 100b may include a first substrate 10b, a second substrate 20b, and a third substrate 30b. The third substrate 30b, the second substrate 20b, and the first substrate 10b may be sequentially stacked in a direction D3, perpendicular to a plane of the substrates 10b-30b (a plane parallel to D1 and D2).

In an example embodiment, some circuits PG_a, PG_b, and PG_c of a pixel group may be formed on one of the first substrate 10b and the second substrate 20b. A first partial circuit PG_a of the pixel group may be disposed on the first substrate 10b, while the remaining second partial circuits PG_b and PG_c of the pixel group may be disposed on the second substrate 20b. The third substrate 30b may include logic, such as a readout circuit, a timing controller, or an image signal processor, and an interface circuit. The readout circuit may include an analog-to-digital converter (ADC).

An array of circuits constituting the pixel group on the first substrate 10b and the second substrate 20b is not limited thereto.

The first substrate 10b and the second substrate 20b may be electrically connected to each other.

In an example embodiment, the first substrate 10b and the second substrate 20b may transmit pixel signals or control signals through a through-silicon via TSV disposed in the peripheral region of the substrate.

In an example embodiment, the first partial circuit PG_a of the pixel group on the first substrate 10b and the second partial circuit PG_b of the pixel group on the second substrate 20b may also be electrically connected through a first inter-substrate connection structure INTC_1. The inter-substrate connection structure INTC_1 may be a C2C bonding contact or a deep-contact structure. The deep-contact structure may include a through-silicon via. The inter-substrate connection structure INTC_1 may electrically connect elements of the first partial circuit PG_a of the pixel group to elements of the second partial circuit PG_b of the pixel group.

In an example embodiment, the first substrate 10b and/or the second substrate 20b may be electrically connected to the third substrate 30b through a through-silicon via TSV and/or a second inter-substrate connection structure INTC_2. Signals from the first substrate 10b and/or the second substrate 20b may be transmitted to a readout circuit (or an image signal processor) of the third substrate 30b through the through-silicon via TSV and/or the second inter-substrate connection structure INTC_2.

In an example embodiment, the second partial circuit PG_b of the pixel group may be electrically connected to the circuits of the third substrate 30b through a C2C bonding contact. The second inter-substrate connection structure INTC_2 may include a C2C bonding contact.

In an example embodiment, the third partial circuit PG_c of the pixel group may be electrically connected to circuits of the third substrate 30b through through-silicon copper (TSC).

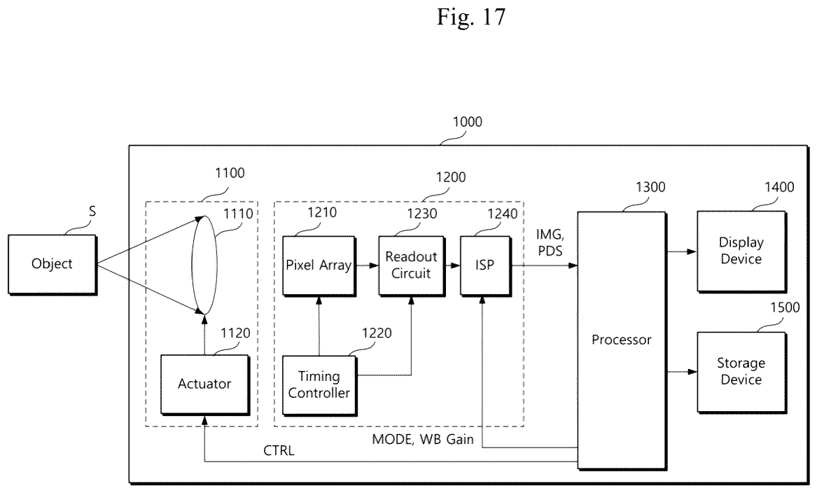

FIG. 17 is a block diagram of an imaging device 1000 according to an example embodiment. Detailed descriptions of features identical or similar to those in the previous embodiments are omitted to avoid redundancy.

The imaging device 1000 may include an imaging unit 1100, an image sensor 1200, a processor 1300, a display device 1400, and a storage device 1500.

The processor 1300 may control overall operations of the imaging device 1000. The processor 1300 may provide a control signal CTRL to an actuator 1120 to control a position of a lens 1110. As a result, a focal length of the lens 1110 may be controlled.

The imaging unit 1100, as a light-receiving component, may include the lens 1110 and the actuator 1120. The lens 1110 may include a plurality of lenses.

The actuator 1120 may move the lens 1110 in a direction in which a distance from an object S increases or decreases, based on the control signal CTRL from the processor 1300.

The image sensor 1200 may generate image data and phase data based on incident light. The image sensor 1200 may include a pixel array 1210, a timing controller 1220, a readout circuit 1230, and an image signal processor (ISP) 1240.

Pixels of the pixel array 1210 may include at least one photoelectric conversion element.

The image sensor 1200 according to an example embodiment may receive mode information MODE and white balance gain WB Gain from the processor 1300.

Pixel groups of the pixel array 1210 may output a first pixel signal and a second pixel signal based on the mode information MODE. For example, the pixel groups of the pixel array 1210 may output the pixel signals described in FIGS. 7 to 10 in preview mode.

The image signal processor 1240 may generate a first pseudo-image signal of the first pixel group in the example embodiments described above, using the white balance gain WB Gain.

The image signal processing unit 1240 may transmit HDR image data IMG and a phase difference signal PDS to the processor 1300.

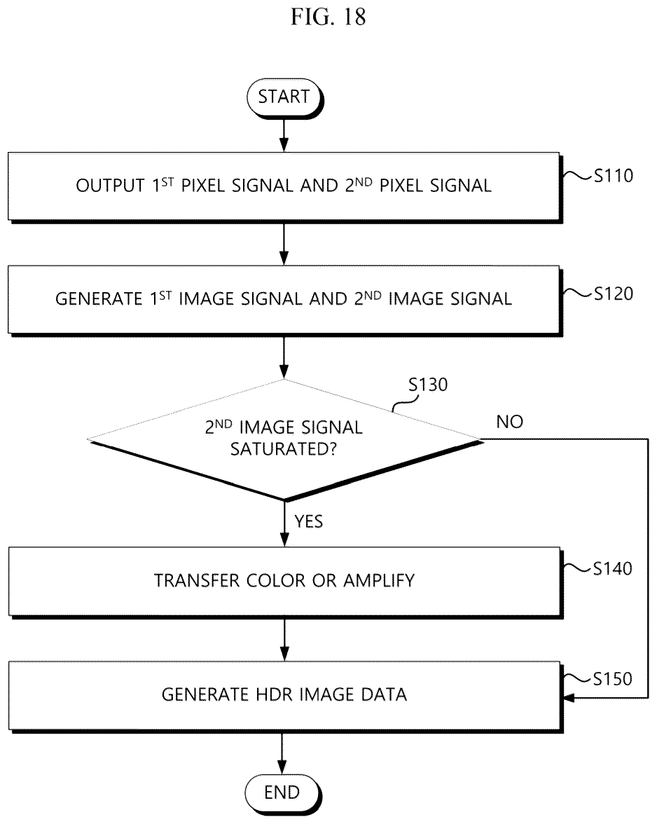

FIG. 18 is a flowchart illustrating a method of operating an image sensor to generate HDR image data according to an example embodiment.

The method of FIG. 18 may be performed in the image sensor 100 of FIG. 1. The method of operating the image sensor 100 will be described with reference to FIGS. 1 and 18.

In operation S110, pixel groups of the image sensor 100 may output a first pixel signal and a second pixel signal. The first pixel signal may include a (1-1)-th pixel signal and a (1-2)-th pixel signal.

A portion of the pixel groups may output a (1-1)-th pixel signal obtained by summing pixel signals of first pixels disposed at positions with opposite phase information with respect to a microlens. For example, the first pixels may be disposed at positions symmetrical in the horizontal direction with respect to a vertical central axis of the microlens. The first pixels may have opposite phase information in at least one of the horizontal and vertical directions with respect to the microlens.

Another portion of the pixel groups may output a (1-2)-th pixel signal obtained by summing the pixel signals of second pixels disposed at positions with the same phase information with respect to a microlens. For example, the second pixels may be disposed at the same positions in the horizontal direction with respect to the vertical central axis of the microlens within the pixel group. The second pixels may have the same phase information in both the horizontal and/or vertical directions with respect to the microlens.

Accordingly, an array of the first pixels may be different from an array of the second pixels.

In operation S120, the readout circuit 150 may generate a first image signal based on the first pixel signal and a second image signal based on the second pixel signal.

In operation S130, the image signal processing circuit 160 may determine whether the second image signals of the pixel groups are saturated.

In operation S140, when the second image signal is saturated, the image signal processing circuit 160 may generate a first virtual image of the first pixel group and/or second virtual images of the second pixel group and the third pixel group, based on at least one of Equation 1, Equation 2, and Equation 3. The image signal processing circuit 160 may generate the first pseudo-image signal of the first pixel group by amplifying the first image signal of the first pixel group by a factor of n. The amplification factor n may be a sensitivity ratio of the HDR image.

In operation S150, the image signal processing circuit 160 may generate HDR image data using the first virtual image of the first pixel group and/or the second virtual images of the second pixel group and the third pixel group.

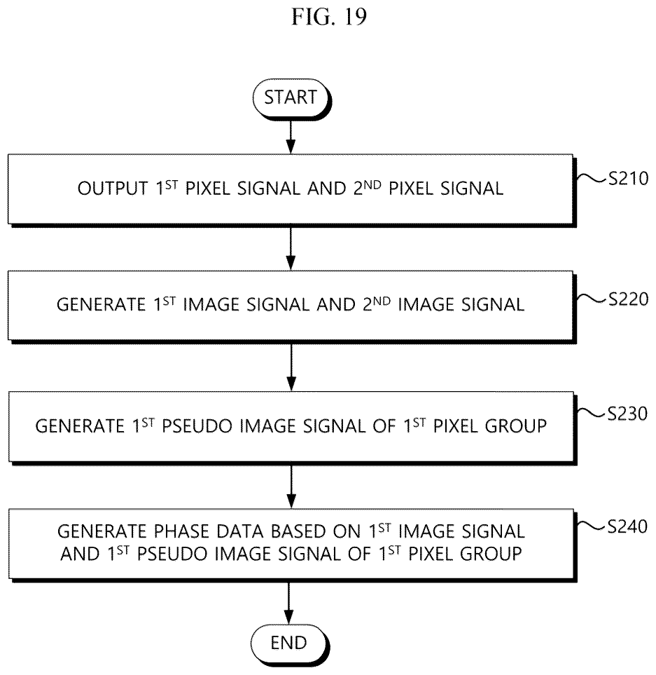

FIG. 19 is a flowchart illustrating a method of operating an image sensor to generate phase data according to an example embodiment.

The method of FIG. 19 may be performed in the image sensor 100 of FIG. 1. The method of operating the image sensor 100 will be described with reference to FIGS. 1 and 19.

Operations S210 and S220 may be the same as operations S110 and S120 of FIG. 18, respectively, and repeated descriptions are omitted to avoid redundancy.

In operation S230, the image signal processing circuit 160 may generate a first pseudo-image signal of the first pixel group based on Equation 3. For example, as described with reference to FIG. 6, the image signal processing circuit 160 may generate the first pseudo-image signal GAL of the first pixel group based on Equation 3.

In operation S240, the image signal processing circuit 160 may generate phase data using the first pseudo-image signal and the first image signal of the first pixel group. For example, as described in the example embodiment of FIG. 13, the AF processing circuit 162 of FIG. 13 may generate the phase data.

As set forth above, according to example embodiments, an image sensor may generate image data having high dynamic range (HDR) and phase information for autofocus across a wide illuminance range.

While example embodiments have been shown and described above, it will be apparent to those skilled in the art that modifications and variations could be made without departing from the scope of the present disclosure as defined by the appended claims and their equivalents.

What is claimed is:

1. An image sensor comprising:
a pixel array comprising a plurality of pixel groups and configured to output a pixel signal; and
a readout circuit configured to output a first image signal based on the pixel signal output during a first readout period, and output a second image signal based on the pixel signal output during a second readout period,
wherein each pixel group of the plurality of pixel groups comprises a plurality of pixels sharing a microlens, and
wherein, during the first readout period, a first pixel group among the plurality of pixel groups is configured to output a (1-1)-th pixel signal obtained by summing pixel signals of some pixels disposed at positions with opposite phase information in a predetermined direction with respect to the microlens, and a second pixel group and a third pixel group among the plurality of pixel groups are configured to output a (1-2)-th pixel signal obtained by summing pixel signals of some pixels disposed at positions with the same phase information in the predetermined direction with respect to the microlens.

2. The image sensor of claim 1, wherein the readout circuit is configured to:
output the first image signal of each pixel group of the plurality of pixel groups based on pixel signals of a portion of the plurality of pixels during the first readout period; and
output the second image signal of each pixel group of the plurality of pixel groups based on pixel signals of all of the plurality of pixels during the second readout period.

3. The image sensor of claim 1, further comprising:
a color filter array disposed on the pixel array,
wherein the color filter array comprises a red color filter, a green color filter, and a blue color filter,
wherein the first pixel group corresponds to the green color filter and is configured to output a pixel signal based on a green optical signal,
wherein the second pixel group corresponds to the blue color filter and is configured to output a pixel signal based on a blue optical signal, and
wherein the third pixel group corresponds to the red color filter and is configured to output a pixel signal based on a red optical signal.

4. The image sensor of claim 1, wherein each pixel group of the plurality of pixel groups comprises at least one microlens.

5. The image sensor of claim 1, wherein, during the first readout period, the first pixel group is configured to output the (1-1)-th pixel signal obtained by summing pixel signals of some pixels disposed symmetrically in a horizontal direction and corresponding to the microlens, and
wherein the second pixel group and the third pixel group are configured to output the (1-2)-th pixel signals obtained by summing pixel signals of some pixels disposed along the horizontal direction and corresponding to the microlens.

6. The image sensor of claim 1, wherein, during the first readout period, the first pixel group is configured to output the (1-1)-th pixel signal obtained by summing pixel signals of some pixels disposed below different microlenses and configured to sense optical signals with opposite phase information in a horizontal direction, and
wherein the second pixel group and the third pixel group are configured to output the (1-2)-th pixel signal obtained by summing pixel signals of some pixels disposed below different microlenses and configured to sense optical signals with the same phase information in the horizontal direction.

7. The image sensor of claim 1, wherein, during the first readout period, the first pixel group is configured to output the (1-1)-th pixel signal obtained by summing pixel signals of some pixels disposed below the same microlens and configured to sense optical signals with opposite phase information in a horizontal direction, and
wherein the second pixel group and the third pixel group are configured to output the (1-2)-th pixel signal obtained by summing pixel signals of some pixels disposed below the same microlens and configured to sense optical signals with the same phase information in the horizontal direction.

8. The image sensor of claim 1, further comprising:
an image signal processing circuit configured to generate image data based on the first image signal and the second image signal,
wherein the image signal processing circuit is configured to generate at least a portion of high dynamic range (HDR) image data using the first image signal of the first pixel group as a low-sensitivity image signal and a signal, obtained by amplifying the first image signal of the first pixel group, as a high-sensitivity image signal.

9. The image sensor of claim 1, further comprising:
an image signal processing circuit configured to generate image data based on the first and second image signals,
wherein the image signal processing circuit is configured to generate HDR image data using the first image signal of each of the second pixel group and the third pixel group as a low-sensitivity image signal and the second image signal of each of the second pixel group and the third pixel group as a high-sensitivity image signal.

10. The image sensor of claim 9, wherein the image signal processing circuit is configured to, in response to detecting that the second image signal of the second pixel group or the third pixel group is saturated:
restore a saturated second image signal of the second pixel group or the third pixel group based on a ratio of the first image signal of the second pixel group or the third pixel group and a first image signal and a second image signal of a fourth pixel group; and
generate the HDR image data based on the restored second image signal of the second pixel group or the third pixel group, and
wherein the fourth pixel group is adjacent to the second pixel group or the third pixel group in which the second image signal is saturated.

11. The image sensor of claim 9, wherein the image signal processing circuit is configured to, in response to detecting that second image signals of both the second pixel group and the third pixel group is saturated:
restore a saturated second image signal of each of the second pixel group and the third pixel group based on a ratio of a signal obtained by amplifying the first image signal of the first pixel group and a third image signal of the first pixel group, and the first image signal of each of the second pixel group and the third pixel group; and
generate at least a portion of the HDR image data based on the restored second image signal of each of the second pixel group and the third pixel group and
wherein the image signal processing circuit is further configured to generate the third image signal of the first pixel group based on the first image signal of the second pixel group and the first image signal of the third pixel group.

12. The image sensor of claim 1, further comprising:
an image signal processing circuit configured to generate phase data based on the first image signal and the second image signal,
wherein the image signal processing circuit is configured to:
generate a third image signal of the first pixel group based on the first image signal of the second pixel group and the first image signal of the third pixel group; and
generate the phase data based on the first image signal of the first pixel group and the third image signal of the first pixel group.

13. The image sensor of claim 12, wherein the image signal processing circuit is configured to:
generate a fourth image signal of the first pixel group based on a difference between the third image signal of the first pixel group and the first image signal of the first pixel group; and
generate the phase data based on the third image signal of the first pixel group and the fourth image signal of the first pixel group.

14. The image sensor of claim 12, wherein the image signal processing circuit is configured to, in response to detecting that the second image signal of the second pixel group or the second image signal of the third pixel group is not saturated, generate the phase data further based on:
the first image signal of the second pixel group and the second image signal of the second pixel group, or
the first image signal of the third pixel group and the second image signal of the third pixel group.

15. An image sensor comprising:
a pixel array comprising a plurality of pixel groups and configured to output a first pixel signal during a first readout period and output a second pixel signal during a second readout period, for each pixel group of the plurality of pixel groups;
at least one microlens disposed above each pixel group of the plurality of pixel groups to overlap each pixel group of the plurality of pixel groups in a direction perpendicular to a substrate of the image sensor, and shared by a plurality of pixels; and
a readout circuit configured to output image signals based on the first pixel signal and the second pixel signal,
wherein during the first readout period, a first pixel group among the plurality of pixel groups is configured to output, as the first pixel signal, a (1-1)-th pixel signal obtained by summing pixel signals of first pixels, and a second pixel group and a third pixel group among the plurality of pixel groups is configured to output, as the first pixel signal, a (1-2)-th pixel signal obtained by summing pixel signals of second pixels, and
wherein the first pixels in the first pixel group are disposed symmetrically in a horizontal direction with respect to a vertical central axis of the at least one microlens, and the second pixels in the second and third pixel groups are disposed at positions along the horizontal direction.

16. The image sensor of claim 15, wherein the readout circuit is configured to output a first image signal during the first readout period based on the first pixel signal and output a second image signal during the second readout period based on the second pixel signal and
wherein, in each pixel group of the plurality of pixel groups, a magnitude of the first image signal is smaller than a magnitude of the second image signal.

17. The image sensor of claim 15, wherein an array in which the first pixels are disposed in the first pixel group is different from an array in which the second pixels are disposed in the second pixel group and the third pixel group.

18. The image sensor of claim 15, wherein each pixel group of the plurality of pixel groups comprises a plurality of pixels disposed at positions with different phase information in the horizontal direction and a plurality of pixels disposed at positions with the same phase information in the horizontal direction.

19. The image sensor of claim 15, further comprising:
an image signal processing circuit configured to generate phase data based on the image signals,
wherein the image signal processing circuit is configured to generate the phase data using a first pseudo-image signal based on the (1-2)-th pixel signal of the second pixel group and the third pixel group, and a first image signal based on the (1-1)-th pixel signal.

20. A method of operating an image sensor, the method comprising:
outputting, by a plurality of pixel groups, a first pixel signal and a second pixel signal;
outputting, by a readout circuit, a first image signal and a second image signal based on the first pixel signal and the second pixel signal, respectively; and
outputting, by an image signal processing circuit, phase data based on the first image signal and the second image signal,
wherein the first pixel signal comprises a (1-1)-th pixel signal and a (1-2)-th pixel signal, and
wherein at least one pixel group among the plurality of pixel groups is configured to output the (1-1)-th pixel signal obtained by summing pixel signals of some pixels disposed at positions with opposite phase information and corresponding to a microlens, and other pixel groups among the plurality of pixel groups are configured to output the (1-2)-th pixel signal obtained by summing pixel signals of some pixels disposed at positions with the same phase information and corresponding to the microlens.
